(19) United States
(12) Patent Application Publication
(10) Pub. No.: US 2026/0343617 A1
(43) Pub. Date: Oct. 29, 2026

(54) PHYSICAL RANDOM ACCESS CHANNEL (PRACH) TRANSMISSION USING FREQUENCY HOPPING BACKSCATTERED SIGNAL

(71) Applicant: QUALCOMM Incorporated, San Diego, CA (US)

(72) Inventors: Luanxia YANG, Beijing (CN); Piyush GUPTA, Bridgewater, NJ (US); Xiaojie WANG, Hillsborough, NJ (US); Junyi LI, Greentown, PA (US)

(21) Appl. No.: 19/126,234

(22) PCT Filed: Dec. 23, 2022
(86) PCT No.: PCT/CN2022/141353

§ 371 Date: Apr. 30, 2025

(51) Int. Cl. H04W 74/0833; H04L 5/00

(52) U.S. Cl. CPC H04W 74/0833; H04L 5/0005

(57) ABSTRACT

Systems and techniques are provided for wireless communication. For example, an apparatus can receive, from a network entity, a Physical Random Access Channel (PRACH) configuration indicative of one or more subsets of time-frequency resources from a plurality of different subsets of time-frequency resources. The apparatus can receive, from the network entity, a radio frequency (RF) signal. The apparatus can further transmit, based on a backscatter modulation of the RF signal using a frequency hopping pattern, a PRACH signal using a particular subset of time-frequency resources from the one or more subsets of time-frequency resources.

### FIELD

Aspects of the present disclosure generally relate to wireless communication. In some implementations, examples are described for Physical Random Access Channel (PRACH) signaling using backscattering.

### INTRODUCTION

Wireless communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax), and a fifth-generation (5G) service (e.g., New Radio (NR)). There are presently many different types of wireless communications systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. According to at least one illustrative example, a first apparatus for wireless communication is provided that includes at least one memory and at least one processor coupled to the at least one memory. The at least one processor is configured to: receive, from a network entity, a Physical Random Access Channel (PRACH) configuration indicative of one or more subsets of time-frequency resources from a plurality of different subsets of time-frequency resources; receive, from the network entity, a radio frequency (RF) signal; and transmit, based on a backscatter modulation of the RF signal using a frequency hopping pattern, a PRACH signal using a particular subset of time-frequency resources from the one or more subsets of time-frequency resources.

In another illustrative example, a method of wireless communication performed by a first apparatus is provided. The method includes: receiving, from a network entity, a Physical Random Access Channel (PRACH) configuration indicative of one or more subsets of time-frequency resources from a plurality of different subsets of time-frequency resources; receiving, from the network entity, a radio frequency (RF) signal; and transmitting, based on a backscatter modulation of the RF signal using a frequency hopping pattern, a PRACH signal using a particular subset of time-frequency resources from the one or more subsets of time-frequency resources.

In another illustrative example, a non-transitory computer-readable medium is provided that has stored thereon instructions that, when executed by one or more processors, cause the one or more processors to: receive, from a network entity, a Physical Random Access Channel (PRACH) configuration indicative of one or more subsets of time-frequency resources from a plurality of different subsets of time-frequency resources; receive, from the network entity, a radio frequency (RF) signal; and transmit, based on a backscatter modulation of the RF signal using a frequency hopping pattern, a PRACH signal using a particular subset of time-frequency resources from the one or more subsets of time-frequency resources.

In another illustrative example, an apparatus for wireless communication is provided. The apparatus includes: means for receiving, from a network entity, a Physical Random Access Channel (PRACH) configuration indicative of one or more subsets of time-frequency resources from a plurality of different subsets of time-frequency resources; means for receiving, from the network entity, a radio frequency (RF) signal; and means for transmitting, based on a backscatter modulation of the RF signal using a frequency hopping pattern, a PRACH signal using a particular subset of time-frequency resources from the one or more subsets of time-frequency resources

In another illustrative example, a network entity for wireless communication is provided that includes at least one memory and at least one processor coupled to the at least one memory. The at least one processor is configured to: transmit, to an energy harvesting (EH)-capable device, a Physical Random Access Channel (PRACH) configuration indicative of one or more subsets of time-frequency resources from a plurality of different subsets of time-frequency resources; transmit, to the EH-capable device, a radio frequency (RF) signal; and receive, from the EH-capable device, a PRACH signal using a particular subset of time-frequency resources from the one or more subsets of time-frequency resources.

In another illustrative example, a method of wireless communication by a network entity is provided. The method includes: transmitting, to an energy harvesting (EH)-capable device, a Physical Random Access Channel (PRACH) configuration indicative of one or more subsets of time-frequency resources from a plurality of different subsets of time-frequency resources; transmitting, to the EH-capable device, a radio frequency (RF) signal; and receiving, from the EH-capable device, a PRACH signal using a particular subset of time-frequency resources from the one or more subsets of time-frequency resources.

In another illustrative example, a non-transitory computer-readable medium is provided that has stored thereon instructions that, when executed by one or more processors, cause the one or more processors to: transmit, to an energy harvesting (EH)-capable device, a Physical Random Access Channel (PRACH) configuration indicative of one or more subsets of time-frequency resources from a plurality of different subsets of time-frequency resources; transmit, to the EH-capable device, a radio frequency (RF) signal; and receive, from the EH-capable device, a PRACH signal using a particular subset of time-frequency resources from the one or more subsets of time-frequency resources.

In another illustrative example, an apparatus for wireless communication is provided. The apparatus includes: means for transmitting, to an energy harvesting (EH)-capable device, a Physical Random Access Channel (PRACH) configuration indicative of one or more subsets of time-frequency resources from a plurality of different subsets of time-frequency resources; means for transmitting, to the EH-capable device, a radio frequency (RF) signal; and means for receiving, from the EH-capable device, a PRACH signal using a particular subset of time-frequency resources from the one or more subsets of time-frequency resources.

Aspects generally include a method, apparatus, system, computer program product, non-transitory computer-readable medium, user equipment, base station, wireless communication device, and/or processing system as substantially described herein with reference to and as illustrated by the drawings and specification.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment (UE), in accordance with some examples;

FIG. 5 is a diagram illustrating an example of a radio frequency (RF) energy harvesting device, in accordance with some examples;

FIG. 6 is a diagram illustrating an example of an ambient Internet-of-Things (IoT) device including a backscatter transmitter and an active transmitter, in accordance with some examples;

FIG. 7 is a diagram illustrating an example PRACH using inner layer fixed size frequency hopping and outer layer pseudo-random frequency hopping, in accordance with some examples;

FIG. 8 is a diagram illustrating an example PRACH frequency grid structure with an asymmetric frequency grid spacing, in accordance with some examples;

FIG. 9 is a diagram illustrating examples of different subset groupings of a plurality of PRACH time-frequency resources, in accordance with some examples;

FIG. 10A is a diagram illustrating a first example of a fixed size frequency hopping pattern, in accordance with some examples;

FIG. 10B is a diagram illustrating a second example of a fixed size frequency hopping pattern, in accordance with some examples;

FIG. 11A is a diagram illustrating a first example of simultaneous PRACH transmissions using a same frequency hopping pattern and two different frequency hopping step sizes, in accordance with some examples;

FIG. 11B is a diagram illustrating a second example of simultaneous PRACH transmissions using a same frequency hopping pattern and two different frequency hopping step sizes, in accordance with some examples;

FIG. 12A is a diagram illustrating a pseudo-random frequency hopping pattern, in accordance with some examples;

FIG. 12B is a diagram illustrating a frequency hopping pattern that includes pseudo-random frequency hopping step sizes and fixed frequency hopping step sizes, in accordance with some examples;

FIG. 13A is a diagram illustrating an example of PRACH transmission using repetition of a frequency hopping pattern, in accordance with some examples;

FIG. 13B is a diagram illustrating an example of PRACH transmission using repetition of a frequency hopping pattern and a pseudo-random frequency hopping step size between repetitions, in accordance with some examples;

FIG. 14 is a flow diagram illustrating an example of a process for wireless communications, in accordance with some examples;

FIG. 15 is a flow diagram illustrating an example of a process for wireless communications, in accordance with some examples; and

FIG. 16 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Wireless communication networks can be deployed to provide various communication services, such as voice, video, packet data, messaging, broadcast, any combination thereof, or other communication services. A wireless communication network may support both access links and sidelinks for communication between wireless devices. An access link may refer to any communication link between a client device (e.g., a user equipment (UE), a station (STA), or other client device) and a base station (e.g., a 3GPP gNB for 5G/NR, a 3GPP eNB for 4G/LTE, a Wi-Fi access point (AP), or other base station). For example, an access link may support uplink signaling, downlink signaling, connection procedures, etc. An example of an access link is a Uu link or interface (also referred to as an NR-Uu) between a 3GPP gNB and a UE.

In various wireless communication networks, various client devices can be utilized that may be associated with different signaling and communication needs. For example, as 5G networks expand into industrial verticals and the quantity of deployed Internet-of-Things (IoT) devices grows, network service categories such as enhanced Mobile Broadband (eMBB), Ultra Reliable Low Latency Communications (URLLC), and massive Machine Type Communications (mMTC), etc., may be expanded to better support various IoT devices, which can include passive IoT devices, semi-passive IoT devices, ambient IoT devices, etc.

For example, passive IoT devices and semi-passive IoT devices are relatively low-cost UEs that may be used to implement one or more sensing and communication capabilities in an IoT network or deployment. In some examples, passive and/or semi-passive IoT sensors (e.g., devices) can be used to provide sensing capabilities for various processes and use cases, such as asset management, logistics, warehousing, manufacturing, etc. Passive and semi-passive IoT devices can include one or more sensors, a processor or micro-controller, and an energy harvester for generating electrical power from incident downlink radio frequency (RF) signals received at the passive or semi-passive IoT device.

Based on harvesting energy from incident downlink RF signals (e.g., transmitted by a network device such as a base station, gNB, etc.), energy harvesting devices (e.g., such as passive IoT devices, semi-passive IoT devices, etc.) can be provided without an energy storage element and/or can be provided with a relatively small energy storage element (e.g., battery, capacitor, etc.) Energy harvesting devices can be deployed at large scales, based on the simplification in their manufacture and deployment associated with implementing wireless energy harvesting.

In a wireless communication network environment (e.g., cellular network, etc.), a network device (e.g., such as a base station or gNB, etc.) can be used to transmit downlink RF signals to energy harvesting devices. In one illustrative example, a base station or gNB can read and/or write information stored on energy harvesting IoT devices by transmitting the downlink RF signal. A downlink RF signal can provide energy to an energy harvesting IoT device and can be used as the basis for an information-bearing uplink signal transmitted back to the network device by the energy harvesting IoT device (e.g., based on reflecting or backscattering a portion of the incident downlink RF signal). The base station or gNB can read the reflected signal transmitted by an energy harvesting IoT device to decode the information transmitted by the IoT device (e.g., such as sensor information collected by one or more sensors included in the IoT device, etc.).

In some examples, for a given downlink signal with a given input RF power received at an energy harvesting device, a first portion of the input RF power is provided to the device's energy harvester (e.g., with a percentage being converted to useful electrical power based on the conversion efficiency of the harvester, and the remaining percentage wasted or dissipated as heat, etc.). A remaining, second portion of the input RF power is available for use in the backscattered uplink transmission (e.g., the second portion of the input power is reflected and modulated with the uplink communication).

Ambient IoT devices can include both a backscatter transmitter (e.g., a backscatter radio) and an active transmitter (e.g., an active radio). A backscatter transmitter can generate and transmit an uplink signal by reflecting and backscatter modulating and incident downlink signal. In some examples, an ambient IoT device can use a backscatter transmitter that is the same as or similar to a backscatter transmitter utilized by a passive or semi-passive IoT device. An active transmitter can use a battery or other energy storage element included in the ambient IoT device to generate and transmit an uplink signal. To transmit an uplink signal, the backscatter transmitter of an ambient IoT device must first receive a downlink signal that can be reflected and backscatter modulated. For example, the backscatter transmitter may be unable to transmit an uplink signal unless or until a continuous sine wave is received as a downlink signal from a base station, gNB, or other network device. The active transmitter of an ambient IoT device can perform uplink communication that is triggered by the ambient IoT device (e.g., without dependence on first receiving a downlink signal).

Ambient IoT devices may include only a small battery or energy storage element and may be unable to sustain longer periods of uplink communication using the active transmitter of the ambient IoT device. For example, active transmission by an ambient IoT device may quickly deplete the onboard battery or other energy storage element(s) included in the ambient IoT device.

Physical Random Access Channel (PRACH) signals and communications can be used by a UE (e.g., such as an ambient IoT device) to align its uplink transmissions to a base station or gNB and gain access to (e.g., connect to) a wireless network associated with the base station or gNB. For example, PRACH can be used for initial access requests from a UE to a base station and to obtain time synchronization. To access the network, the UE can request access by transmitting a random access (RA) preamble through PRACH. The RA preamble can be detected by a PRACH receiver at the base station, which estimates the ID of the transmitted preamble and a propagation delay between the UE and the base station. The base station and UE are then time-synchronized according to a time alignment (TA) value (e.g., determined from the propagation delay estimate) transmitted from the base station prior to the uplink transmission.

In some examples, an ambient IoT device performs network registration and/or PRACH transmission using the active transmitter included in the ambient IoT device. For example, because an ambient IoT device may be unregistered and/or unable to access the wireless network prior to the PRACH transmission, the ambient IoT device may not receive a downlink signal from a base station (e.g., included in the network) that the ambient IoT device can use to perform passive transmission using its backscatter transmitter. There is a need for systems and techniques that can be used to perform PRACH transmissions using a passive (e.g., backscattering) transmitter of a UE. There is a further need for systems and techniques that can be used to perform backscattered PRACH transmission using one or more network configured resources.

Systems, apparatuses, processes (also referred to as methods), and computer-readable media (collectively referred to as “systems and techniques”) are described herein that can be used to provide improved backscatter modulation-based communications between a UE and a network node or transmitter (e.g., gNB, base station, etc.). For example, the systems and techniques described herein can be used to perform PRACH transmission between a UE and a network node using a backscatter transmitter included in the UE. In some examples, the UE can be an energy harvesting device (e.g., passive, semi-passive, or active IoT device, an ambient IoT device, etc.). In some cases, the UE can transmit a PRACH signal to a network node using one or more network configured resources (e.g., time-frequency resources). The PRACH signal can be transmitted based on a backscatter modulation of an input RF signal received by the UE from a network node (e.g., an energy signal, continuous sine wave, etc.), using one or more frequency hopping patterns.

In some cases, the UE can synchronize with the network node and/or the wireless communication network associated with the network node and may receive a PRACH configuration. The PRACH configuration can be indicative of one or more subsets or groups of network resources that can be used to transmit a PRACH signal. In some examples, the PRACH configuration can be indicative of subset of network resources (e.g., time-frequency resources) that are assigned to the UE by the network node for transmission of a backscatter modulated, frequency hopping PRACH signal. In some cases, the PRACH configuration can be indicative of multiple different subsets of network resources (e.g., time-frequency resources) that can be used to transmit a PRACH signal. Based on the PRACH configuration, the UE can select a subset of time-frequency resources to use for transmitting the backscatter modulated, frequency hopping PRACH signal. In some cases, one or more additional parameters of the PRACH transmission by the UE can be indicated (e.g., by the network node) using the PRACH configuration and/or one or more additional parameters of the PRACH transmission can be determined by the UE based on the PRACH transmission.

Further aspects of the systems and techniques will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAV) or drone, helicopter, airship, glider, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.), and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (e.g., a network of spatially separated antennas connected to a common source via a transport medium) or a remote radio head (RRH) (e.g., a remote base station connected to a serving base station). Alternatively, the non-co-located physical TRPs may be the serving base station receiving the measurement report from the UE and a neighbor base station whose reference radio frequency (RF) signals (e.g., or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

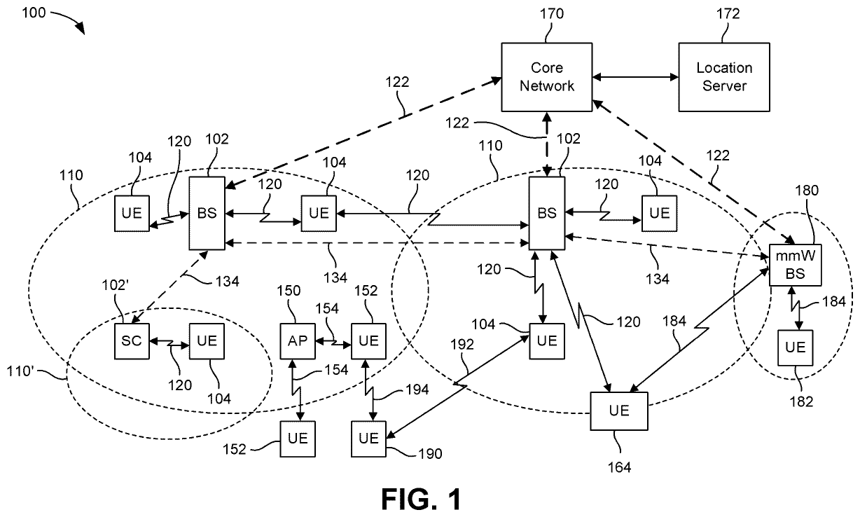

Various aspects of the systems and techniques described herein will be discussed below with respect to the figures. According to various aspects, FIG. 1 illustrates an example of a wireless communications system 100. The wireless communications system 100 (e.g., which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers may be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device.

Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or other receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based on a signal that was transmitted in one or more beam directions. For example, a UE 104 may receive one or more of the signals transmitted by the base station 102 in different directions and may report to the base station 104 an indication of the signal that the UE 104 received with a highest signal quality or an otherwise acceptable signal quality.

In some examples, transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc., utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHZ with a wavelength of 100 millimeters. The super high frequency (SHF) band extends between 3 GHz and 30 GHZ, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FRI (e.g., from 450 to 6,000 Megahertz (MHz)), FR2 (e.g., from 24,250 to 52,600 MHz), FR3 (e.g., above 52,600 MHz), and FR4 (e.g., between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (e.g., x component carriers) for transmission in each direction. The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (e.g., an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y’.

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

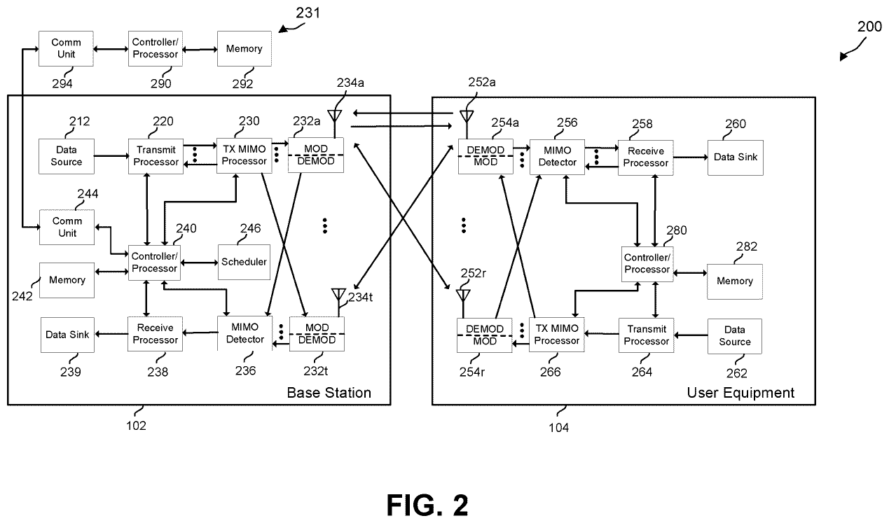

FIG. 2 illustrates a block diagram of an example architecture 200 of a base station 102 and a UE 104 that enables transmission and processing of signals exchanged between the UE and the base station, in accordance with some aspects of the present disclosure. Example architecture 200 includes components of a base station 102 and a UE 104, which may be one of the base stations 102 and one of the UEs 104 illustrated in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based on channel quality indicators (CQIs) received from the UE, process (e.g., encode and modulate) the data for each UE based on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream (e.g., for an orthogonal frequency-division multiplexing (OFDM) scheme and/or the like) to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to one or more demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based on a beta value or a set of beta values associated with the one or more reference signals). The symbols from transmit processor 264 may be precoded by a TX-MIMO processor 266, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 (e.g., if applicable), and further processed by a receive processor 238 to obtain decoded data and control information sent by UE 104. Receive processor 238 may provide the decoded data to a data sink 239 and the decoded control information to controller (e.g., processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (e.g., such as a Node B (NB), evolved NB (eNB), NR BS, 5G NB, access point (AP), a transmit receive point (TRP), or a cell, etc.) may be implemented as an aggregated base station (e.g., also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (e.g., such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (e.g., such as the network configuration sponsored by the O-RAN Alliance)), or a virtualized radio access network (e.g., vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

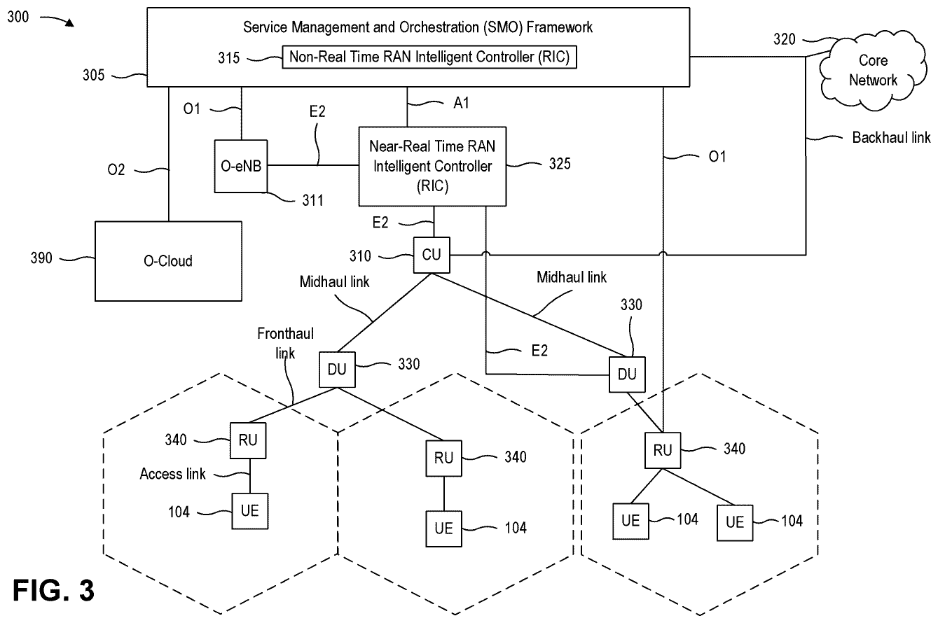

FIG. 3 is a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (e.g., such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 104 via one or more radio frequency (RF) access links. In some implementations, the UE 104 may be simultaneously served by multiple RUs 340.

Each of the units (e.g., the CUS 310, the DUs 330, the RUs 340, as well as the Near-RT RICs 325, the Non-RT RICs 315, and the SMO Framework 305) illustrated in FIG. 3 and/or described herein may include one or more interfaces or be coupled to one or more interfaces configured to receive or transmit signals, data, or information (e.g., collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (e.g., such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (e.g., such as modules for forward error correction (FEC) encoding and decoding, scrambling, modulation and demodulation, or the like) depending on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (e.g., such as performing fast Fourier transform (FFT), inverse FFT (iFFT), digital beamforming, physical random-access channel (PRACH) extraction and filtering, or the like), or both, based on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (e.g., such as an O1 interface). For virtualized network elements, the SMO Framework 305 may be configured to interact with a cloud computing platform (e.g., such as an open cloud (O-Cloud) 390) to perform network element life cycle management (e.g., such as to instantiate virtualized network elements) via a cloud computing platform interface (e.g., such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (e.g., such as via an A1 interface) the Near-RT RIC 325. The Near-RT RIC 325 may be configured to include a logical function that enables near-real-time control and optimization of RAN elements and resources via data collection and actions over an interface (e.g., such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (e.g., such as reconfiguration via 01) or via creation of RAN management policies (e.g., such as A1 policies).

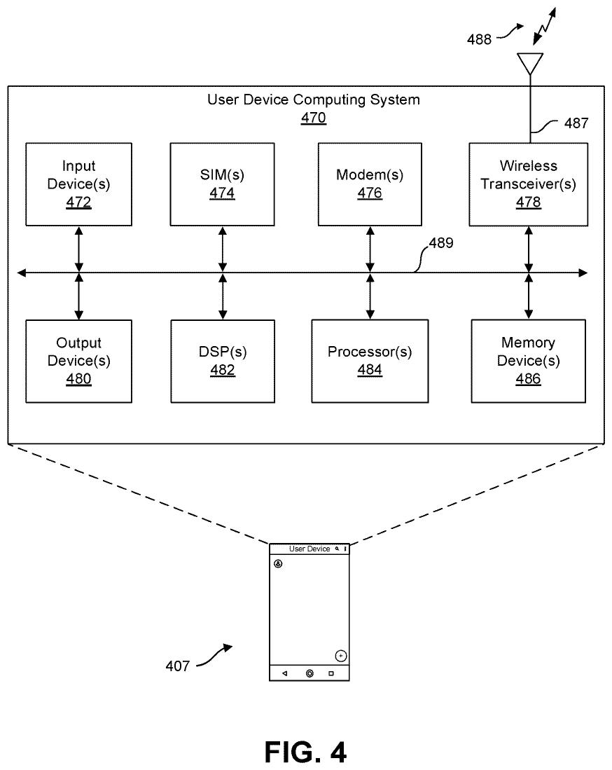

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR), or mixed reality (MR) device, etc.), Internet of Things (IoT) device, a vehicle, an aircraft, and/or another device that is configured to communicate over a wireless communications network. The computing system 470 includes software and hardware components that may be electrically or communicatively coupled via a bus 489 (e.g., or may otherwise be in communication, as appropriate). For example, the computing system 470 includes one or more processors 484. The one or more processors 484 may include one or more CPUs, ASICS, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

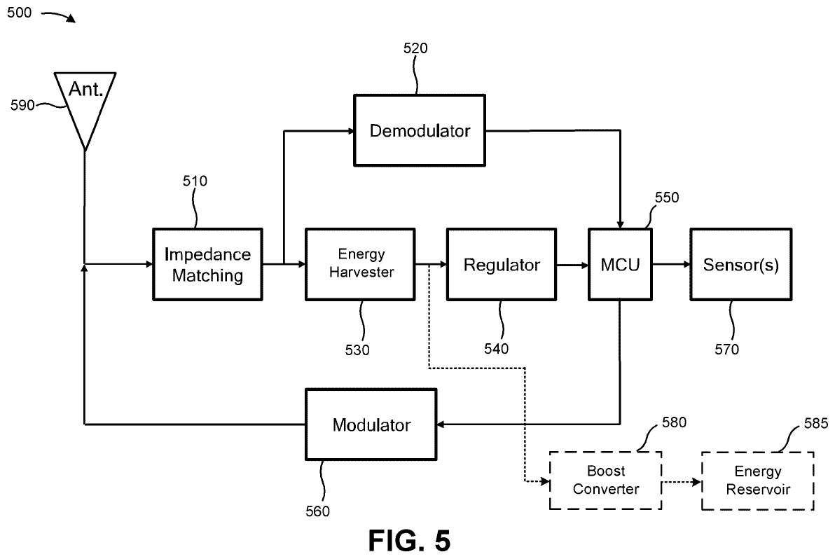

FIG. 5 is a diagram illustrating an example of an architecture of a radio frequency (RF) energy harvesting device 500, in accordance with some examples. As will be described in greater depth below, the RF energy harvesting device 500 can harvest RF energy from one or more RF signals received using an antenna 590. As used herein, the term “energy harvesting” may be used interchangeably with “power harvesting.” In some aspects, an “energy harvesting device” can be a device that is capable of performing energy harvesting (EH). For example, as used herein, the term “energy harvesting device” may be used interchangeably with the term “EH-capable device” or “energy harvesting-capable device.” In some aspects, energy harvesting device 500 can be implemented as an Internet-of-Things (IoT) device, can be implemented as a sensor, etc., as will be described in greater depth below. For example, energy harvesting device 500 can be an ambient-IoT device. As used herein, an energy harvesting device (e.g., EH-capable device) may also be referred to as an “ambient-IoT device”. In other examples, energy harvesting device 500 can be implemented as a Radio-Frequency Identification (RFID) tag or various other RFID devices.

The energy harvesting device 500 includes one or more antennas 590 that can be used to transmit and receive one or more wireless signals. For example, energy harvesting device 500 can use antenna 590 to receive one or more downlink signals and to transmit one or more uplink signals. An impedance matching component 510 can be used to match the impedance of antenna 590 to the impedance of one or more (or all) of the receive components included in energy harvesting device 500. In some examples, the receive components of energy harvesting device 500 can include a demodulator 520 (e.g., for demodulating a received downlink signal), an energy harvester 530 (e.g., for harvesting RF energy from the received downlink signal), a regulator 540, a micro-controller unit (MCU) 550, a modulator 560 (e.g., for generating an uplink signal). In some cases, the receive components of energy harvesting device 500 may further include one or more sensors 570.

The downlink signals can be received from one or more transmitters. For example, energy harvesting device 500 may receive a downlink signal from a network node or network entity that is included in a same wireless network as the energy harvesting device 500. In some cases, the network entity can be a base station, gNB, etc., that communicates with the energy harvesting device 500 using a cellular communication network. For example, the cellular communication network can be implemented according to the 3G, 4G, 5G, and/or other cellular standard (e.g., including future standards such as 6G and beyond).

In some cases, energy harvesting device 500 can be implemented as a passive or semi-passive energy harvesting device, which perform passive uplink communication by modulating and reflecting a downlink signal received via antenna 590. A passive or semi-passive energy harvesting device may also be referred to as a passive or semi-passive EH-capable device, respectively. For example, passive and semi-passive energy harvesting devices may be unable to generate and transmit an uplink signal without first receiving a downlink signal that can be modulated and reflected. In other examples, energy harvesting device 500 may be implemented as an active energy harvesting device (e.g., also referred to as an “active EH-capable device”), which utilizes a powered transceiver to perform active uplink communication. An active energy harvesting device is able to generate and transmit an uplink signal without first receiving a downlink signal (e.g., by using an on-device power source to energize its powered transceiver).

An active or semi-passive energy harvesting device may include one or more energy storage elements 585 (e.g., collectively referred to as an “energy reservoir”). For example, the one or more energy storage elements 585 can include batteries, capacitors, etc. In some examples, the one or more energy storage elements 585 may be associated with a boost converter 580. The boost converter 580 can receive as input at least a portion of the energy harvested by energy harvester 530 (e.g., with a remaining portion of the harvested energy being provided as instantaneous power for operating the energy harvesting device 500). In some aspects, the boost converter 580 may be a step-up converter that steps up voltage from its input to its output (e.g., and steps down current from its input to its output). In some examples, boost converter 580 can be used to step up the harvested energy generated by energy harvester 530 to a voltage level associated with charging the one or more energy storage elements 585. An active or semi-passive energy harvesting device may include one or more energy storage elements 585 and may include one or more boost converters 580. A quantity of energy storage elements 585 may be the same as or different than a quantity of boost converters 580 included in an active or semi-passive energy harvesting device.

A passive energy harvesting device (e.g., also referred to as a “passive EH-capable device”) does not include an energy storage element 585 or other on-device power source. For example, a passive energy harvesting device may be powered using only RF energy harvested from a downlink signal (e.g., using energy harvester 530). As mentioned previously, a semi-passive energy harvesting device can include one or more energy storage elements 585 and/or other on-device power sources. The energy storage element 585 of a semi-passive energy harvesting device can be used to augment or supplement the RF energy harvested from a downlink signal. In some cases, the energy storage element 585 of a semi-passive energy harvesting device may store insufficient energy to transmit an uplink communication without first receiving a downlink communication (e.g., minimum transmit power of the semi-passive device >capacity of the energy storage element). An active energy harvesting device can include one or more energy storage elements 585 and/or other on-device power sources that can power uplink communication without using supplemental harvested RF energy (e.g., minimum transmit power of the active device <capacity of the energy storage element). The energy storage element(s) 585 included in an active energy harvesting device and/or a semi-passive energy harvesting device can be charged using harvested RF energy.

As mentioned above, passive and semi-passive energy harvesting devices transmit uplink communications by performing backscatter modulation to modulate and reflect a received downlink signal. The received downlink signal is used to provide both electrical power (e.g., to perform demodulation, local processing, and modulation) and a carrier wave for uplink communication (e.g., the reflection of the downlink signal). For example, a portion of the downlink signal will be backscattered as an uplink signal and a remaining portion of the downlinks signal can be used to perform energy harvesting.

Active energy harvesting devices can transmit uplink communications without performing backscatter modulation and without receiving a corresponding downlink signal (e.g., an active energy harvesting device includes an energy storage element to provide electrical power and includes a powered transceiver to generate a carrier wave for an uplink communication). In the absence of a downlink signal, passive and semi-passive energy harvesting devices cannot transmit an uplink signal (e.g., passive communication). Active energy harvesting devices do not depend on receiving a downlink signal in order to transmit an uplink signal and can transmit an uplink signal as desired (e.g., active communication).

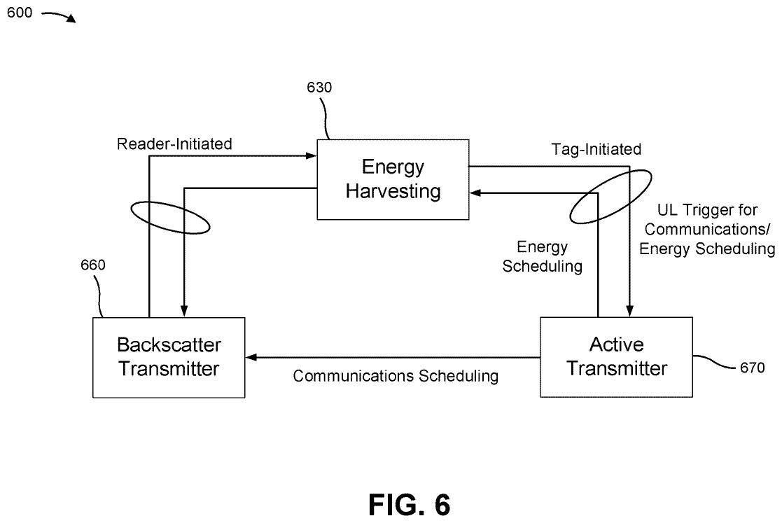

In some aspects, ambient IoT devices can include both a backscatter transmitter (e.g., a backscatter radio) and an active transmitter (e.g., an active radio). Ambient IoT devices may also be referred to as energy harvesting devices or EH-capable devices, as noted previously. For example, in some cases an ambient IoT device may be implemented as a combination of a passive or semi-passive energy harvesting device and an active energy harvesting device. An example ambient IoT device will be described in greater depth below with respect to FIG. 6.

Returning to the discussion of FIG. 5, in examples in which the energy harvesting device 500 is implemented as a passive or semi-passive energy harvesting device, a continuous carrier wave downlink signal may be received using antenna 590 and modulated (e.g., re-modulated) for uplink communication. In some cases, a modulator 560 can be used to modulate the reflected (e.g., backscattered) portion of the downlink signal. For example, the continuous carrier wave may be a continuous sinusoidal wave (e.g., sine or cosine waveform) and modulator 560 can perform modulation based on varying one or more of the amplitude and the phase of the backscattered reflection. Based on modulating the backscattered reflection, modulator 560 can encode digital symbols (e.g., such as binary symbols or more complex systems of symbols) indicative of an uplink communication or data message. For example, the uplink communication may be indicative of sensor data or other information associated with the one or more sensors 570 included in energy harvesting device 500.

As mentioned previously, impedance matching component 510 can be used to match the impedance of antenna 590 to the receive components of energy harvesting device 500 when receiving the downlink signal (e.g., when receiving the continuous carrier wave). In some examples, during backscatter operation (e.g., when transmitting an uplink signal), modulation can be performed based on intentionally mismatching the antenna input impedance to cause a portion of the incident downlink signal to be scattered back. The phase and amplitude of the backscattered reflection may be determined based on the impedance loading on the antenna 590. Based on varying the antenna impedance (e.g., varying the impedance mismatch between antenna 590 and the remaining components of energy harvesting device 500), digital symbols and/or binary information can be encoded (e.g., modulated) onto the backscattered reflection. Varying the antenna impedance to modulate the phase and/or amplitude of the backscattered reflection can be performed using modulator 560.

As illustrated in FIG. 5, a portion of a downlink signal received using antenna 590 can be provided to a demodulator 520, which performs demodulation and provides a downlink communication (e.g., carried or modulated on the downlink signal) to a micro-controller unit (MCU) 550 or other processor included in the energy harvesting device 500. A remaining portion of the downlink signal received using antenna 590 can be provided to energy harvester 530, which harvests RF energy from the downlink signal. For example, energy harvester 530 can harvest RF energy based on performing AC-to-DC (alternating current-to-direct current) conversion, wherein an AC current is generated from the sinusoidal carrier wave of the downlink signal and the converted DC current is used to power the energy harvesting device 500. In some aspects, energy harvester 530 can include one or more rectifiers for performing AC-to-DC conversion. A rectifier can include one or more diodes or thin-film transistors (TFTs). In one illustrative example, energy harvester 530 can include one or more Schottky diode-based rectifiers. In some cases, energy harvester 530 can include one or more TFT-based rectifiers.

The output of the energy harvester 530 is a DC current generated from (e.g., harvested from) the portion of the downlink signal provided to the energy harvester 530. In some aspects, the DC current output of energy harvester 530 may vary with the input provided to the energy harvester 530. For example, an increase in the input current to energy harvester 530 can be associated with an increase in the output DC current generated by energy harvester 530. In some cases, MCU 550 may be associated with a narrow band of acceptable DC current values. Regulator 540 can be used to remove or otherwise decrease variation(s) in the DC current generated as output by energy harvester 530. For example, regulator 540 can remove or smooth spikes (e.g., increases) in the DC current output by energy harvester 530 (e.g., such that the DC current provided as input to MCU 550 by regulator 540 remains below a first threshold). In some cases, regulator 540 can remove or otherwise compensate for drops or decreases in the DC current output by energy harvester 530 (e.g., such that the DC current provided as input to MCU 550 by regulator 540 remains above a second threshold).

In some aspects, the harvested DC current (e.g., generated by energy harvester 530 and regulated upward or downward as needed by regulator 530) can be used to power MCU 550 and one or more additional components included in the energy harvesting device 500. For example, the harvested DC current can additionally be used to power one or more (or all) of the impedance matching 510, demodulator 520, regulator 540, MCU 550, sensors 570, modulator 560, etc. For example, sensors 570 and modulator 560 can receive at least a portion of the harvested DC current that remains after MCU 550 (e.g., that is not consumed by MCU 550). In some cases, the harvested DC current output by regulator 540 can be provided to MCU 550, modulator 560, and sensors 570 in series, in parallel, or a combination thereof.

In some examples, sensors 570 can be used to obtain sensor data (e.g., such as sensor data associated with an environment in which the energy harvesting device 500 is located). Sensors 570 can include one or more sensors, which may be of a same or different type(s). In some aspects, one or more (or all) of the sensors 570 can be configured to obtain sensor data based on control information included in a downlink signal received using antenna 590. For example, one or more of the sensors 570 can be configured based on a downlink communication obtained based on demodulating a received downlink signal using demodulator 520. In one illustrative example, sensor data can be transmitted based on using modulator 560 to modulate (e.g., vary one or more of amplitude and/or phase of) a backscatter reflection of the continuous carrier wave received at antenna 590. Based on modulating the backscattered reflection, modulator 560 can encode digital symbols (e.g., such as binary symbols or more complex systems of symbols) indicative of an uplink communication or data message. In some examples, modulator 560 can generate an uplink, backscatter modulated signal based on receiving sensor data directly from sensors 570. In some examples, modulator 560 can generate an uplink, backscatter modulated signal based on received sensor data from MCU 550 (e.g., based on MCU 550 receiving sensor data directly from sensors 570).

FIG. 6 is a diagram illustrating an example of an ambient Internet-of-Things (IoT) device 600. In some cases, an ambient IoT device (e.g., such as ambient IoT device 600) may also be referred to as an ultra-light IoT device. Ambient IoT device 600 can include an energy harvester 630, which can be used to harvest energy from one or more downlink energy signals (e.g., RF signals) received as input. In some examples, energy harvester 630 can be the same as or similar to energy harvester 530 illustrated in FIG. 5. In some cases, energy harvester 630 can include one or more of the components included in the energy harvesting device 500 illustrated in FIG. 5. For example, energy harvester 630 can include one or more (or all) of the energy harvester 530, regulator 540, boost converter 580, energy storage element(s) 585, etc.

As mentioned previously, ambient IoT devices (e.g., such as the ambient IoT device 600) can include both a backscatter transmitter (e.g., a backscatter radio) and an active transmitter (e.g., an active radio). For example, ambient IoT device includes a backscatter transmitter 660 and an active transmitter 670. In one illustrative example, backscatter transmitter 660 can generate and transmit an uplink signal by reflecting and backscatter modulating and incident downlink signal (e.g., received at energy harvester 630 and subsequently provided to backscatter transmitter 660). Backscatter transmitter 660 can include one or more (or all) of the demodulator 520, modulator 560, antenna 590, MCU 550, etc., illustrated in the energy harvesting device 500 of FIG. 5.

Active transmitter 670 can use a battery or other energy storage element (e.g., the same as or similar to energy storage element 585 illustrated in FIG. 5) included in the ambient IoT device 600 to generate and transmit an uplink signal. For example, the ambient IoT device 600 can include a battery or other energy storage element, energy harvester 630 can include a battery or other energy storage element, and/or active transmitter 670 can include a battery or other energy storage element, etc.

To transmit an uplink signal, the backscatter transmitter 660 must first receive a downlink signal that can be reflected and backscatter modulated. In some aspects, uplink communication performed using backscatter transmitter 660 can be referred to as “reader-initiated” communications (e.g., based on backscatter transmitter 660 receiving a downlink RF signal from a network device, base station, gNB, or “reader”). To transmit an uplink signal using active transmitter 670, ambient IoT device 600 does not need to receive a corresponding downlink RF signal. Ambient IoT device 600 can use active transmitter 670 to perform uplink communication that is triggered by the ambient IoT device 600 (e.g., also referred to as “device-initiated” communications, or “tag-initiated” communications in examples where the ambient IoT device 600 is implemented as a tag).

In some examples, energy harvester 630 can provide power (e.g., electrical energy or current) to ambient IoT device 600 based on performing energy harvesting and/or using one or more batteries or energy storage elements. In one illustrative example, ambient IoT device 600 can utilize active transmitter 670 (e.g., and stored energy from a battery or energy storage element) to perform device-initiated communications with a network node (e.g., base station, gNB, etc.). In some cases, the device-initiated communication can include or be indicative of an uplink (UL) trigger for communication scheduling and/or for energy scheduling. For example, active transmitter 670 can be used to perform device-initiated communication with a network node to request an energy transmission be scheduled or performed immediately, to request one or more modifications or updates to the energy signal(s) transmitted from the network node to the ambient IoT device 600, etc. In some cases, active transmitter 670 can be used to perform device-initiated communication with a network node to schedule one or more communications between the ambient IoT device 600 and the network node.

In one illustrative example, ambient IoT device 600 can use active transmitter 670 to schedule an upcoming backscatter modulated communication by the ambient IoT device 600. For example, based on a communication scheduling information transmitted via active transmitter 670 of ambient IoT device 600, the network node can subsequently transmit a downlink RF signal to the ambient IoT device 600 at a scheduled time (e.g., using one or more scheduled time-frequency resources). By using active transmitter 670 to request a downlink RF signal from the network node at a future time, ambient IoT device 600 can subsequently use backscatter transmitter 660 to perform scheduled communications with the network node.

In some aspects, ambient IoT device 600 can perform backscattering with a frequency shift and/or can perform backscattering without a frequency shift. For example, backscattering without a frequency shift can be performed based on using backscatter transmitter 660 (e.g., and a modulator included in or associated with backscatter transmitter 660) to perform amplitude-shift keying (ASK) modulation and/or phase-shift keying (PSK) modulation of a reflected (e.g., backscattered) downlink RF signal. In some cases, backscattering without a frequency shift may be associated with self-interference. For example, the backscatter modulated signal and the corresponding downlink RF signal used to generate the backscatter modulated signal are transmitted and received, respectively, on the same frequency or frequency band. The backscatter modulated signal and the corresponding downlink RF signal also overlap in time, either partially or wholly (e.g., because the backscatter modulated signal is only generated and transmitted while the corresponding downlink RF signal is being received at the ambient IoT device 600).

In one illustrative example, ambient IoT device 600 can perform backscattering with one or more frequency shifts. In some aspects, the one or more frequency shifts can be used to implement additional modulation schemes at backscatter transmitter 660 (e.g., modulation schemes other than ASK or PSK). Implementing frequency shifts and/or additional modulation schemes can, in some cases, be associated with increased complexity and/or energy consumption at the ambient IoT device 600. For example, a larger frequency shift (e.g., larger Δf) may be associated with a greater energy consumption than a smaller frequency shift (e.g., smaller Δf) or no frequency shift (e.g., zero Δf).

In some aspects, a backscattering frequency shift can be implemented using one or more square waves (e.g., or portions of a square wave). For example, ambient IoT device 600 (e.g., and/or other UEs that include a backscatter transmitter) can frequency shift a backscattered signal (e.g., reflected downlink RF signal) using one or more square waves. In one illustrative example, for an incoming signal Sᵢₙ that includes a plurality of symbols, ambient IoT device 600 can perform frequency shifting based on combining the symbols included in incoming signal Sᵢₙ with a respective or corresponding square wave (e.g., or portion thereof). For example, an incoming symbol S_{in,0} can be combined with a (square wave) o, an incoming symbol S_{in,1} can be combined with a (square wave) 1, . . . , and an incoming symbol Sᵢₙ,n can be combined with a (square wave) n. In some cases, a Fourier approximation of a square wave function square (t) used to implement a backscattering frequency shift f_{shift} can be given as:

$$square ( {f}_{shift} t ) = \frac{4}{π} {\sum }_{n = 1 , 3 , 5 , …}^{∞} \frac{1}{n} sin ( 2 π n {f}_{shift} t ) \qquad Eq . ( 1 )$$

As mentioned previously, Physical Random Access Channel (PRACH) signals and communications can be used by a UE (e.g., such as the ambient IoT device 600) to align its uplink transmissions to a base station or gNB and gain access to (e.g., connect to) a wireless network associated with the base station or gNB. For example, PRACH can be used for initial access requests from a UE to a base station and to obtain time synchronization. To access the network, the UE can request access by transmitting a random access (RA) preamble through PRACH. The RA preamble can be detected by a PRACH receiver at the base station, which estimates the ID of the transmitted preamble and a propagation delay between the UE and the base station. The base station and UE are then time-synchronized according to a time alignment (TA) value (e.g., determined from the propagation delay estimate) transmitted from the base station prior to the uplink transmission.

In one illustrative example, ambient IoT device 600 can use active transmitter 670 to transmit an initial network access or network registration request to a network node. Based on PRACH configuration information received from the network node (e.g., using active transmitter 670 and/or using backscatter transmitter 660), the ambient IoT device 600 can use one or more determined or selected time-frequency resources to transmit a PRACH signal to the network node, based on using backscatter transmitter 660 to backscatter modulate the PRACH signal onto a reflected downlink RF signal received from the network node.

In some aspects, the backscatter modulated PRACH signal can be transmitted using frequency hopping. For example, ambient IoT device 600 can use one or more frequency hopping patterns to transmit the backscatter modulated PRACH signal, as will be described in greater depth below.

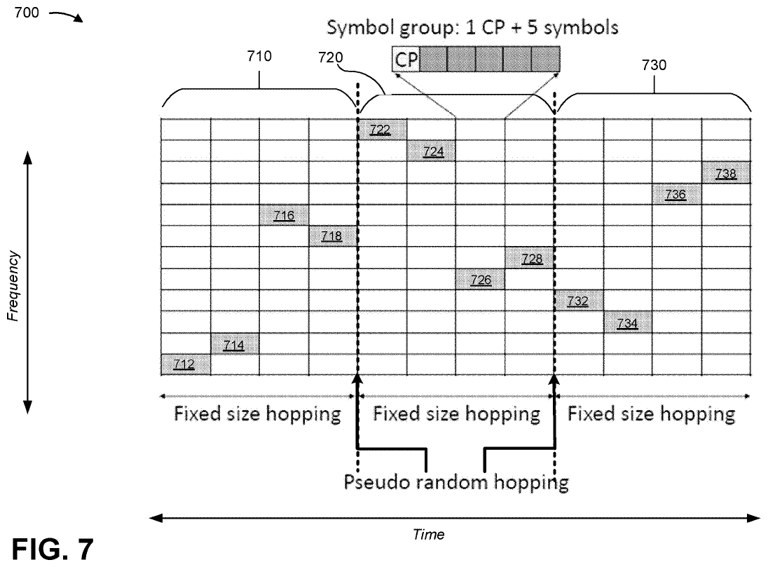

FIG. 7 is a is a diagram illustrating an example PRACH signal transmission using inner layer fixed size frequency hopping and outer layer pseudo-random frequency hopping, in accordance with some examples. A time-frequency grid 700 includes a plurality of time-frequency resources that can be used (e.g., are available) for PRACH transmission. As illustrated, a vertical axis of the time-frequency grid 700 corresponds to frequency (e.g., different frequency resources) and a horizontal axis of the time-frequency grid 700 corresponds to time (e.g., different time resources). Each grid or element within the 12×7 time-frequency grid 700 can be used to transmit one symbol group. In some aspects, each symbol group can include a cyclic prefix (CP) and five symbols.

In the example of FIG. 7, PRACH frequency hopping can be implemented using groups of four consecutive symbol groups. For example, a first group 710 includes symbol groups 712, 714, 716, and 718; a second group 720 includes symbol groups 722, 724, 726, and 728; and a third group 730 includes symbol groups 732, 734, 736, and 738. Inner layer fixed size frequency hopping can be performed by using one or more (e.g., fixed) frequency hopping step sizes within each of the three groups 710, 720, 730. For example, the inner layer fixed size frequency hopping pattern depicted in FIG. 7 is based on a first level single-subcarrier hopping between the first and second symbol groups and between the third and fourth symbol groups included in each of the three groups 710, 720, 730, and a second level six-subcarrier hopping between the second and third symbol groups included in each of the three groups 710, 720, 730.

For example, with respect to the first group 710, a first level single-subcarrier hopping (e.g., frequency hopping step size of one) is performed between first symbol group 712 and second symbol group 714 and is also performed between third symbol group 716 and fourth symbol group 718. A second level six-subcarrier hopping is performed between second symbol group 714 and third symbol group 716.

In some aspects, the two first level single-subcarrier hoppings can be mirrored or reversed relative to one another. For example, if the first single-subcarrier hopping (e.g., from first symbol group 712 to second symbol group 714) is an upward frequency hop, the second single-subcarrier hopping (e.g., from third symbol group 716 to fourth symbol group 718) can be in the opposite direction (e.g., a downward frequency hop). If the first single-subcarrier hopping is a downward frequency hop, the second single-subcarrier frequency hopping can be an upward frequency hop. In some examples, a hopping size of the first and second single-subcarrier hoppings can be based on a cell coverage requirement and/or a timing estimation accuracy requirement. In some aspects, the mirroring or reversal of direction of the first and second single-subcarrier hoppings can be used to mitigate carrier frequency offset. In some cases, the alternating of upward and downward single-subcarrier hoppings can be extended across the groupings of symbol groups. For example, if the first grouping 710 is associated with an “UP” and a “DOWN” single-subcarrier hopping, second grouping 720 can be associated with an “UP” and a “DOWN” single-subcarrier hopping, third grouping 730 can be associated with an “UP” and a “DOWN” single-subcarrier hopping, etc.

The second level six-subcarrier hopping (e.g., from second symbol group 714 to third symbol group 716) can be used to randomize inter-cell interference. In some cases, the second level six-subcarrier hopping can be mirrored or reversed in direction for a given two consecutive groupings of four symbol groups (e.g., between group 710 and 720, between group 720 and 730, etc.). For example, the second level six-subcarrier hopping between the second symbol group 714 and third symbol group 716 included in first grouping 710 is an upward frequency hop. The second level six-subcarrier hopping between the second symbol group 724 and third symbol group 726 included in second grouping 720 can be in the opposite direction (e.g., a downward frequency hop). The second level six-subcarrier hopping between the second symbol group 734 and third symbol group 736 included in third grouping 730 can again be in the opposite or reversed direction (e.g., an upward frequency hop).

In some examples, an outer layer pseudorandom frequency hopping step size can be applied between consecutive groups of four symbol groups (e.g., between group 710 and 720, between group 720 and 730, etc.). In one illustrative example, the outer layer pseudorandom frequency hopping step size can be applied between the last (e.g., fourth symbol group) included in the given grouping and the first (e.g., first symbol group) included in the next grouping. For example, an outer layer pseudorandom frequency hopping can be performed between the fourth symbol group 718 included in the first grouping 710 and the first symbol group 722 included in the second grouping 720, can be performed between fourth symbol group 728 included in the second grouping 720 and the first symbol group 732 included in the third grouping 730, etc. In some examples, the outer layer pseudorandom frequency hopping can have a pseudorandom frequency hopping step size and a pseudorandom frequency hopping direction. For example, between first grouping 710 and second grouping 720, the pseudorandom hopping can have a step size of five and a direction of “UP.” Between second grouping 720 and third grouping 730, the pseudorandom hopping can have a step size of two and a direction of “DOWN.”

In some examples, each frequency hopping step associated with a PRACH signal transmission (e.g., such as that illustrated in the example of FIG. 7) can be given as:

s(t)=sin(2πfᵢt)Rect(t) Eq. (2)

S(f)=F(s(t))=sinc(f−fᵢ)−sinc(f+fᵢ) Eq. (3)

Here, s(t) is a time-domain representation of the backscattered signal transmitted by an ambient IoT device (e.g., or other UE with a backscatter transmitter). The sin(2πfᵢt) term in Eq. (2) can represent a continuous wave downlink signal received at the ambient IoT device. In some aspects, the sin(2πfᵢt) term may additionally, or alternatively, be a square waveform for frequency hopping. For example, at time t₁, fᵢ=f_{c}+f₁ and at time t₂, fᵢ=f_{c}+f₂ (e.g., where f_{c} is the frequency of the downlink signal and f₁ and f₂ are the frequency of the square waveform). Rect(t) represents the length of one hopping (e.g., the length of one hopping along a time axis or in the time domain). In Eq. (3), S(f) is a frequency-domain representation of s(t), based on a Fourier transform F(s(t)).

For a signal time duration, τ, the bandwidth of S(f) is 2/τ. In some cases, latency can be reduced by choosing a minimum frequency separation based on the time duration τ. For example, if the time duration τ is less than or equal to one millisecond, then the minimum frequency hopping separation can be Δf_{hop,min}>2 kHz to minimize or eliminate inter-carrier interference. In some aspects, when multiple hopping is utilized, the minimum frequency separation can be lowered.

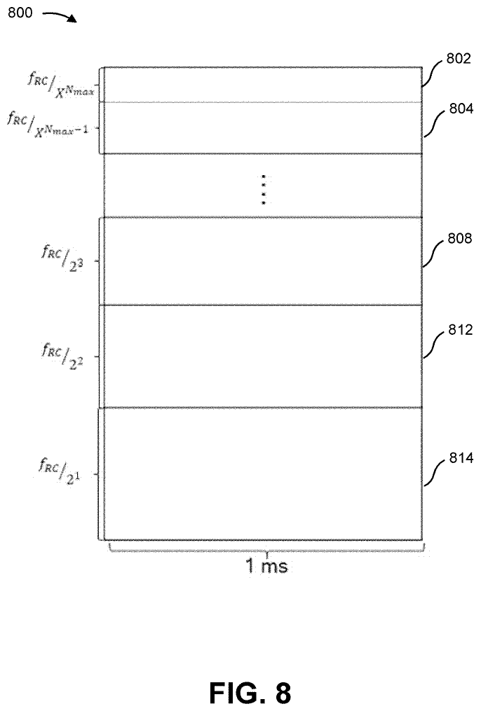

FIG. 8 is a diagram illustrating an example frequency grid structure 800 that may be used to transmit a frequency hopping PRACH signal via backscatter modulation. In some aspects, a given bandwidth can be divided into a plurality of different frequency grids. The frequency grids can be non-overlapping. In some cases, frequency hopping can be performed using an equally spaced frequency grid structure, wherein each frequency grid is the same size. In some aspects, ambient IoT devices and/or other UEs that include a backscatter transmitter may be unable to implement an arbitrary frequency shift. For example, ambient IoT devices and backscattering UEs may be relatively low-cost devices that can implement various frequency shifts but cannot implement any arbitrary frequency shift. In one illustrative example, the systems and techniques described herein can use a frequency hopping pattern and/or a frequency slot structure that is determined based on device capability information.

For example, the frequency grid structure 800 includes a plurality of frequency grids 802, 804, . . . 808, 812, 814. Each frequency grid can have a different size. A first frequency grid 802 can have a size of f_{RC}/X^{N}^{ₘₐₓ} and a second frequency grid 804 can have a (larger) size of f_{RC}/X^{N}^{ₘₐₓ₋₁}. Here, f_{RC} is the reference clock frequency (e.g., the maximum supported frequency shift), X is an integer-valued divider, and Nₘₐₓ is a maximum support division factor of the device (e.g., a device implementing frequency grid structure 800). In some cases, f_{RC} may be less than f_{BW}, which represents the bandwidth (e.g., operating bandwidth) associated with transmitting the frequency hopping PRACH signal. For instance, f_{BW} may represent the operating bandwidth associated with an ambient-IoT device used to transmit a frequency hopping PRACH signal via backscatter modulation and using the example frequency grid structure 800 illustrated in FIG. 8. In some examples, the maximum supported frequency shift f_{RC} can be less than the operating bandwidth f_{BW}.

The divider value, X, can be used to implement frequency hopping (e.g., frequency shifting) for devices that cannot implement an arbitrary frequency shift. For example, the divider X can be a constant integer value that is used to determine the size of each frequency grid included in frequency grid structure 800. In one illustrative example, divide-by-two frequency shifting can be implemented by using X=2.

For example, frequency grid 808 has a size of f_{RC}/2³=f_{RC}/8 and is larger than the preceding frequency grids 802, 804, etc. Frequency grid 812 has a size of (RC/2=f_{RC}/4 and frequency grid 814 has a size of f_{RC}/2¹=f_{RC}/2. In some aspects, when divide-by-two frequency shifting is utilized, adjacent frequency grids may increase or decrease in size by a factor of two. For example, grid 814 is twice as wide as grid 812, which itself is twice as wide as the adjacent grid 808 (e.g., and grid 814 is four times as wide as grid 808). In one illustrative example, when divide-by-two frequency shifting is utilized, a frequency hopping step size of one (e.g., hopping from a given frequency band to an adjacent frequency band directly above or below the given frequency band) can be performed based on doubling the starting frequency or halving the starting frequency.

As mentioned previously, the systems and techniques described herein can use frequency hopping-based backscattering to indicate or transmit one or more PRACH signals (e.g., such as a PRACH preamble, etc.). The PRACH can be transmitted to a same network node associated with transmitting the downlink RF signal that is reflected as the frequency hopping-based backscattered PRACH. In one illustrative example, an ambient IoT device or other UE including a backscatter transmitter can receive a continuous waveform from a network node and indicate a PRACH signal by backscattering the continuous waveform at different frequencies at different times.

In some aspects, the ambient IoT device can use a frequency hopping pattern Δtᵢ=[Δfₜ_{ₒ} . . . Δfₜ_{_{M-1}}]. In some examples, the ambient IoT device may be unable to perform arbitrary frequency shifts and may utilize a pre-determined frequency grid structure and/or a pre-determined frequency hopping pattern. For example, the ambient IoT device may utilize a pre-determined frequency grid structure that is the same as or similar to the divide-by-two grid structure 800 illustrated in FIG. 8. In one illustrative example, the frequency hopping pattern Δfₜ_{ᵢ} can be given as Δfₜ_{ᵢ}=f_{RC}/Xⁿ, where i=1, . . . , M−1 and n=1, . . . , Nₘₐₓ−1.

In some aspects, one or more resources to be used for frequency hopping (e.g., used by an ambient IoT device or other UE including a backscatter transmitter) can be determined by a network node (e.g., such as a base station, gNB, etc.). The network node used to determine the available resources for frequency hopping can be the same network node used to transmit a downlink continuous wave signal to the ambient IoT device for backscattering.

In one illustrative example, the network node can generate and transmit PRACH configuration indicative of a common PRACH resource to be used by all devices. For instance, the PRACH configuration can be indicative of a common subset of PRACH resources to be used by some (or all) devices. For example, the network node can transmit a PRACH configuration indicative of a common set of time-frequency resources that will be shared across one or more ambient IoT devices to each transmit a respective frequency hopping-based backscattered PRACH signal.

In another illustrative example, the network node can divide a time-frequency grid (e.g., including a plurality of different time-frequency resources) into different subsets of time-frequency resources. The network node can generate and transmit PRACH configuration that groups ambient IoT devices (e.g., or other UEs including a backscatter transmitter) into a respective group associated with one of the subsets of time-frequency resources. For example, each group of ambient-IoT devices can be associated with the same subset of time-frequency resources. The group of devices associated with a given subset of the time-frequency resources may include a single device and/or may include multiple devices. In some cases, at least one device is associated with each one of the subsets of time-frequency resources determined by the network node. In some examples, one or more of the subsets of time-frequency resources may be unused (e.g., has no devices associated with it).

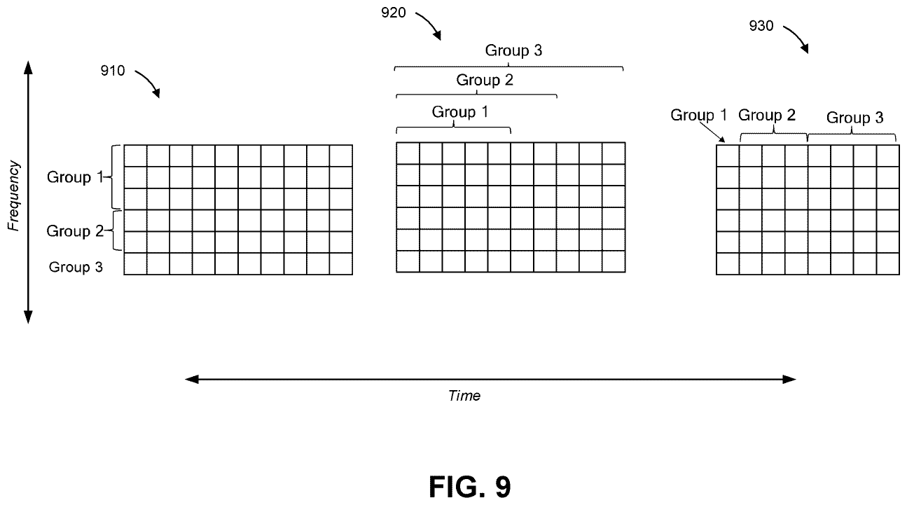

In some aspects, a time-frequency grid can be divided into different subsets of time-frequency resources based on frequency. A group of one or more devices (e.g., ambient-IoT devices) can be assigned to or otherwise associated with each of the subsets of time-frequency resources of the time-frequency grid. For example, FIG. 9 illustrates a time-frequency grid 910 that is divided into three different subsets of time-frequency resources based on frequency, with each subset of time-frequency resources associated with a different group of devices. For example, a first subset of time-frequency resources is associated with a first group of devices (e.g., “Group 1”), a second subset of time-frequency resources is associated with a second group of devices (e.g., “Group 2”), and a third subset of time-frequency resources is associated with a third group of devices (e.g., “Group 3”). As illustrated, frequency is associated with a vertical axis and time is associated with a horizontal axis.

In the example of time-frequency grid 910, each of the three groups (e.g., indicated as Group 1, Group 2, and Group 3) can be associated with a different (e.g., non-overlapping) subset of frequency resources. Each of the three groups can be associated with the same time resources (e.g., based on dividing the time-frequency grid 910 only along the vertical frequency axis), with each group associated with different frequency resources at each given time resource. For example, a first subset of time-frequency resources (e.g., associated with Group 1) can be associated with a first plurality of frequency resources and a second subset of time-frequency resources (e.g., associated with Group 2) can be associated with a second plurality of frequency resources, etc. The first and second plurality of frequency resources can be included in the time-frequency grid 910. The first plurality of frequency resources can be different than the second plurality of frequency resources (e.g., non-overlapping). A group can be associated with a single frequency (e.g., a single row of frequency resources) or can be associated with multiple frequencies (e.g., multiple rows of frequency resources). For example, Group 1 is associated with a subset of time-frequency resources that includes three different frequency resources for each given time resource, Group 2 is associated with a subset of time-frequency resources that includes two different frequency resources for each given time resource, and Group 3 is associated with a subset of time-frequency resources that includes one frequency resource for each given time resource. In some cases, dividing time-frequency grid 910 into different subsets of time-frequency resources based on frequency can be used to reduce collisions between the groups of devices (e.g., ambient-IoT devices) associated with the different subsets of time-frequency resources. For example, collisions may be reduced based on each group of devices being associated with a subset of time-frequency resources that is non-overlapping in frequency with the remaining subsets of time-frequency resources.

In some examples, a time-frequency grid can be divided into different subsets of time-frequency resources based on time. A group of one or more devices (e.g., ambient-IoT devices) can be assigned to or otherwise associated with each of the subsets of time-frequency resources of the time-frequency grid. For example, FIG. 9 illustrates a time-frequency grid 920 that is divided into three different subsets of time-frequency resources based on time, with each subset of time-frequency resources associated with a different group of devices. For example, a first subset of time-frequency resources is associated with a first group of devices (e.g., “Group 1”), a second subset of time-frequency resources is associated with a second group of devices (e.g., “Group 2”), and a third subset of time-frequency resources is associated with a third group of devices (e.g., “Group 3”). In some cases, the time-frequency grid 920 can be the same as the time-frequency grid 910. Each of the three groups (e.g., Group 1, Group 2, Group 3) can be associated with a different subset of the time resources included in time-frequency grid 920. For example, at a given time resource, a device associated with one of the three groups can transmit at any of the frequency resources included in the time-frequency grid 920 (e.g., based on the time-frequency grid 920 being divided only along the horizontal time axis). As illustrated for time-frequency grid 920, the different subsets of time-frequency resources that are divided based on time may be overlapping (e.g., a given time-frequency resource can be included in multiple and/or all of the different subsets). For example, the time-frequency resources included in the subset of time-frequency resources associated with Group 1 are all included in the subset of time-frequency resources associated with Group 2, and the time-frequency resources included in the subset of time-frequency resources associated with Group 2 are all included in the subset of time-frequency resources associated with Group 3 (e.g., wherein the subset of time-frequency resources associated with Group 3 includes all of the time-frequency resources of time-frequency grid 920).

Subsets of overlapping time-frequency resources divided by time can each be associated with a different time duration (e.g., the subset of time-frequency resources associated with Group 1 has a smaller total time duration than the subset of time-frequency resources associated with Group 2 and Group 3, the subset of time-frequency resources associated with Group 2 has a smaller total time duration than the subset of time-frequency resources associated with Group 3, etc.). In some aspects, multiple ambient IoT devices and/or UEs including a backscatter transmitter can transmit a frequency hopping-based PRACH based on the network node assigning (e.g., based on a PRACH configuration message or signal) different hopping repetitions for different subsets of the time-frequency resources. Additionally, or alternatively, the network node may assign or otherwise indicate (e.g., based on a PRACH configuration message or signal) different PRACH transmission starting times for different subsets of the time-frequency resources.

In some cases, a time-frequency grid can be divided into different, non-overlapping subsets of time-frequency resources, based on time division. For example, FIG. 9 illustrates a time-frequency grid 930 that is divided by time into three non-overlapping subsets of time-frequency resources, wherein each of the three subsets of time-frequency resources is associated with a respective group of devices (e.g., ambient-IoT devices). For instance, a given time-frequency resource of the time-frequency grid 930 may be included in only one of the three subsets of time-frequency resources and may be associated with only one of the three corresponding groups of devices). In some aspects, the time-frequency grid 930 can be the same as the time-frequency grid 920 and/or the time-frequency grid 910.

In some examples, a given ambient IoT device (e.g., and/or a given UE including a backscatter transmitter) can transmit a frequency hopping-based backscattered PRACH using a subset of time-frequency resources indicated in a PRACH configuration. The PRACH configuration can be received from a network node (e.g., gNB, base station, etc.). For example, the network node can determine the one or more subsets of time-frequency resources for dividing a given time-frequency grid, select or assign a particular subset of time-frequency resources to an ambient IoT device, and generate and transmit a PRACH configuration indicative of the particular subset of time-frequency resources assigned to the ambient IoT device.

In one illustrative example, the network node can generate and transmit a PRACH configuration indicative of some (or all) of the different subsets of time-frequency resources that are associated with a time-frequency grid (e.g., that are associated with a plurality of available time-frequency resources for PRACH transmission). The network node can further include, in the PRACH configuration, selection information associated with each subset of time-frequency resources. Based on receiving the PRACH configuration indicative of the different subsets of time-frequency resources and the respective, corresponding selection information for each subset, an ambient IoT device can select one of the subsets of time-frequency resources to use as the particular subset for frequency hopping-based backscatter PRACH transmission.

In some examples, the selection information associated with the different subsets of time-frequency resources can be indicative of a traffic type, a coverage level, and/or an energy level, etc., associated with each of the different subsets of time-frequency resources. In one illustrative example, the PRACH configuration may include selection information indicative of different reference signal received power (RSRP) thresholds associated with different subsets of time-frequency resources. Based on the RSRP thresholds associated with the subsets of time-frequency resources, a given ambient IoT device (e.g., or other UE including a backscatter transmitter) can select an appropriate subset of time-frequency resources (e.g., the particular subset of time-frequency resources) based on measuring one or more synchronization signals and comparing the measurements to the RSRP thresholds.

In some cases, a given subset of time-frequency resources may include multiple different starting frequency grids (e.g., each associated with the first time resource included in the given subset of time-frequency resources, multiple different frequency resources may be available). For example, with reference to frequency grid 910, the subset of time-frequency resources associated with Group 1 includes three starting frequencies and the subset of time-frequency resources associated with Group 2 includes two starting frequencies (e.g., while the subset of time-frequency resources associated with Group 3 includes one starting frequency). When multiple starting frequencies are available or included in the subset of time-frequency resources associated with a given device, the device can select or determine a first frequency resource Δfₜ_{ₒ} that will be used for the frequency hopping-based backscattered PRACH. For example, the value of Δfₜ_{ₒ} may be randomly selected from the multiple available starting frequencies. In some aspects, the value of Δfₜ_{ₒ} can be determined based on a hash of an identifier value (e.g., ID value) associated with the ambient IoT device. For example, a starting frequency hop Δfₜ_{ₒ} can be determined as x modulo y, wherein x is the device ID hash and y is the quantity of available starting frequencies. The output of x modulo y is between 0 and y, and this output can be used to select a corresponding one of the available starting frequencies to use for the first hop Δfₜ_{ₒ}.

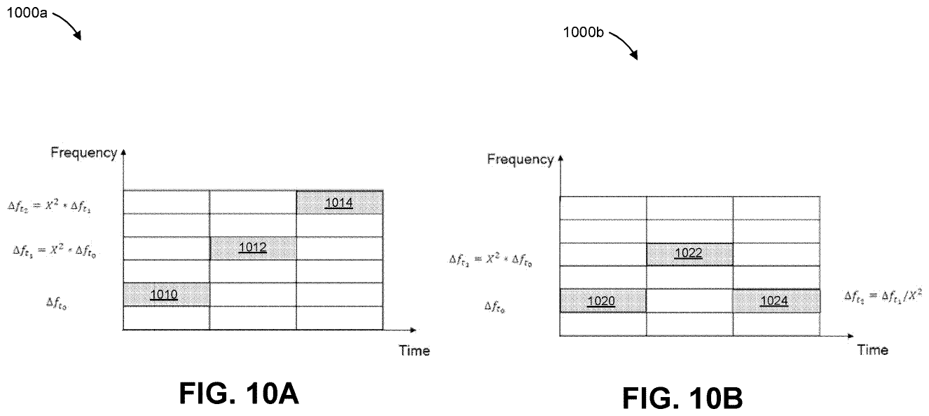

In one illustrative example, a given device (e.g., ambient IoT device, UE including a backscatter transmitter, etc.) can transmit the frequency hopping-based backscatter PRACH using a frequency hopping pattern. The frequency hopping pattern can be a fixed size frequency hopping pattern, can be a pseudo-random frequency hopping pattern, and/or a combination of the two. For example, FIGS. 10A and 10B are diagrams depicting respective first and second examples of a fixed size frequency hopping pattern.

A fixed size frequency hopping pattern can be based on a fixed frequency hopping step size (e.g., also referred to as a “hopping step” or “hop size”). For example, FIG. 10A depicts a fixed size frequency hopping pattern 1000a based on a fixed hop size of two. From a first frequency hop 1010, a second frequency hop 1012 is shifted upwards by two grids (e.g., two frequency resources or sub-carriers). From second frequency hop 1012, a third frequency hop 1014 is shifted upwards by two grids again. In some aspects, a fixed size frequency hopping pattern can have a fixed or constant hop size and may be associated with a fixed or constant hopping direction (e.g., upward or downward/increasing or decreasing in frequency).

In some examples, a fixed size frequency hopping pattern can be based on a fixed hop size that is used to perform both upward and downward hopping. For example, FIG. 10A depicts a fixed size frequency hopping pattern 1000b that includes a fixed hop size of two and utilizes upward and downward hopping. As illustrated, an upward hop of two frequency grids is performed between first frequency hop 1020 and second frequency hop 1022, and a downward hop of two frequency grids is performed between second frequency hop 1022 and third frequency hop 1024. In one illustrative example, a fixed size frequency hopping pattern can include two upward hoppings followed by two downward hoppings. After the second downward hopping, the pattern can be repeated (e.g., UP, UP, DOWN, DOWN, UP, UP, . . . ). In some aspects, a frequency hopping pattern can include a pre-determined pattern for a combination of upward and downward hopping to further reduce a carrier frequency offset (CFO).

In one illustrative example, fixed size frequency hopping patterns (e.g., such as the fixed size frequency hopping patterns 1000a, 1000b) can be associated with a fixed hop size of X^{m}*Δf, where Δf=f_{RC}/X^{N}^{ₘₐₓ}. As described previously above, f_{RC} is the reference clock frequency, X is an integer-valued divider, and Nₘₐₓ is a maximum support division factor of the device.

The fixed hop size X^{m}*Δf can vary across different ambient IoT devices and/or different UEs including a backscatter transmitter. For example, the fixed hop size X^{m}*Δf can vary based on one or more device capabilities and/or supported frequency shifts. In one illustrative example, the value of the divider X can be based on the supported frequency shifts associated with a given device. For example, to implement divide-by-two frequency shifting, X=2 can be used.

The value of m can be used to vary the quantity of frequency grids that are hopped in each given frequency hopping step. For example, FIGS. 10A and 10B depict an example in which a fixed hop size of two is utilized. In these examples, a value of m=2 can be used to implement the fixed hop size of two frequency grids. For example, as illustrated in FIG. 10A, a first hop 1010 is associated with a frequency shift of Δfₜ_{ₒ}. Based on the time-frequency grid of FIG. 10A utilizing asymmetric frequency slots (e.g., each frequency grids having a different size/width, as described with respect to FIG. 8), the Δf frequency shift value associated with hopping by two grids changes based on the starting frequency grid of the hop.

For example, the time-frequency grid of FIG. 10A may implement divide-by-two frequency shifting (e.g., using X=2 to yield a fixed hop size of 2^{m}*Δf), in which case doubling the current frequency shift is associated with an upward shift of one grid and halving the current frequency shift is associated with a downward shift of one grid. For other values of X, an upward shift of one grid can correspond to multiplying the current Δf value by X and a downward shift of one grid can correspond to dividing the current Δf value by X.

For example, referring to first hop 1010 of FIG. 10A, multiplying Δfₜ_{ₒ} by X can cause an upward frequency shift of one grid. An upward frequency shift of two grids can be performed by multiplying by X again. For example, Δfₜ_{ₒ}*X shifts upward from first hop 1010 by one grid and (Δfₜ_{ₒ}*X)*X=Δfₜ_{ₒ}*X² shifts upward from first hop 1010 by two grids. In one illustrative example, the exponent m applied to the divider X can be used to control the number of frequency grids that are hopped in a given frequency hopping step. For example, using the fixed hop size X^{m}*Δf with m=2 can be associated with the fixed two-grid hopping of FIG. 10A.

From first hop 1010 (e.g., Δfₜ_{ₒ}), the frequency shift associated with implementing the subsequent second hop 1012 is given by Δfₜ_{₁}=X²*Δfₜ_{ₒ}. From second hop 1012, the frequency shift associated with implementing the subsequent third hop 1014 is given by Δfₜ_{₂}=X²*Δfₜ_{₁}.

A downward hop can be implemented based on dividing by X^{m}. For example, FIG. 10B illustrates a downward hop from second hop 1022 to third hop 1024. The frequency shift associated with second hop 1022 is Δfₜ_{₁}=X²*Δfₜ_{ₒ} (e.g., the same as in FIG. 10A). The downward hop of two grids can be implemented using a frequency shift Δfₜ_{₂}=Δfₜ_{₁}/X². As illustrated in FIG. 10B, the first hop 1020 and third hop 1024 are associated with the same frequency grid and fₜ_{₂}=Δfₜ_{₁}/X²=(X²*Δfₜ_{ₒ})/X²=Δfₜ_{ₒ}.

In some aspects, for fixed size frequency hopping based on a value of m indicative of the quantity of grids hopped per step, the value of m may be a common value shared across multiple devices that transmit PRACH using the same time-resource grid (e.g., and/or using different subsets thereof). The value of m can be indicated by a network node (e.g., base station or gNB) via the PRACH configuration and/or can be pre-determined by the one or more devices.

In one illustrative example, devices (e.g., ambient IoT devices) associated with the same grouping (e.g., and therefore associated with the same subset of time-frequency resources) can use different frequency hopping step sizes. For example, ambient IoT devices associated with a same subset of time-frequency resources can use different values of m in determining their corresponding hoping step size X^{m}*Δf. In some examples, the value of m can be pre-configured for each respective device and/or can be dynamically indicated by a network node (e.g., base station, gNB, etc.). For example, the network node can indicate the different m values for respective ambient IoT devices associated with the same subset of time-frequency resources using the PRACH configuration.

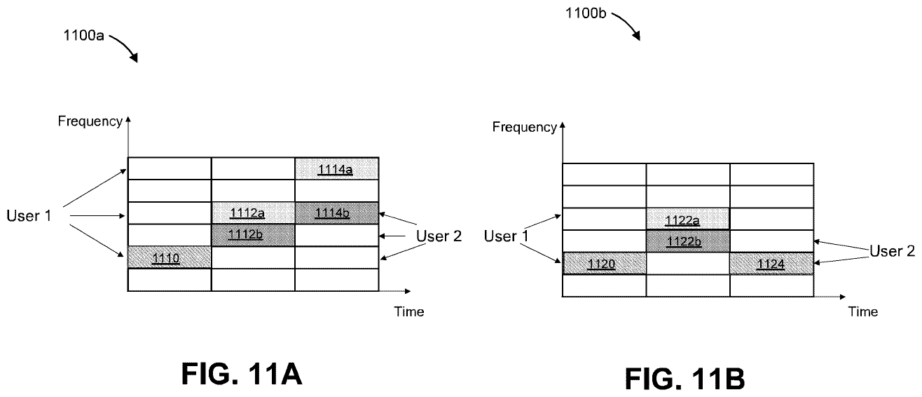

FIGS. 11A and 11B are diagrams illustrating examples of fixed size frequency hopping using different frequency hopping step sizes (e.g., different values of m). FIG. 11A includes a first device (e.g., User 1) and a second device (User 2) that may transmit PRACH using the same time-frequency resources. Both devices are associated with the same starting time-frequency resource at first hop 1110. As illustrated, the first device can perform a fixed two-grid hopping 1110-1112a-1114a that is the same as the fixed two-grid hopping 1010-1012-1014 illustrated in FIG. 10A, based on m=2. The second device can perform a fixed one-grid hopping 1110-1112b-1114b, based on m=1. By utilizing different step sizes within a given group of PRACH resources (e.g., within a given subset of time-frequency resources), multiple devices can transmit frequency hopping-based backscattered PRACH at a higher capacity and/or with reduced interference and collisions.

FIG. 11B depicts another example of fixed size frequency hopping using different frequency hopping step sizes. A first device (e.g., User 1) and a second device (e.g., User 2) may transmit PRACH using the same time-frequency resources. Both devices are associated with the same starting time-frequency resources at first hop 1120. As illustrated, the first device can perform a fixed two up-two down hopping 1120-1122a-1124 that is the same as the fixed two up-two down hopping 1020-1022-1024 illustrated in FIG. 10B. The second device can perform a fixed one up-one down hopping 1120-1122b-1124.

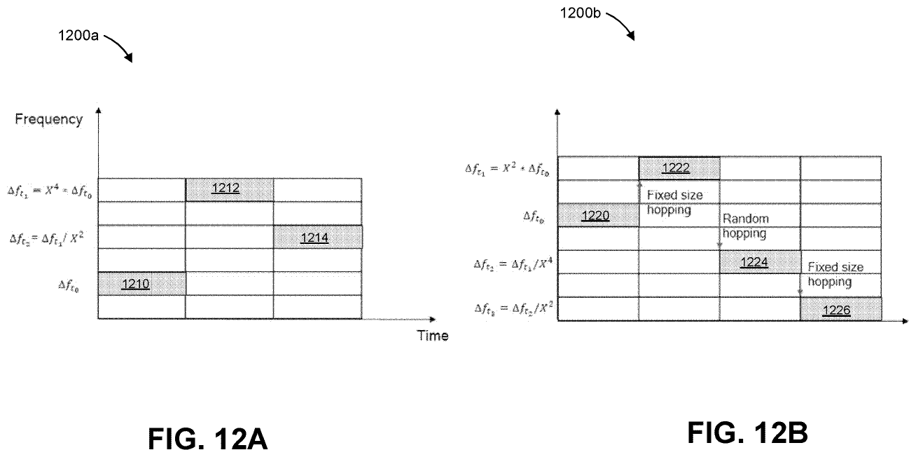

As mentioned previously, a pseudo-random frequency hopping pattern and/or a combined fixed and pseudo-random frequency hopping pattern may also be utilized to transmit frequency hopping-based backscatter PRACH. For example, FIG. 12A illustrates an example of pseudo-random frequency hopping for a set of time-frequency resources 1200a. An upward hop of four grids can be performed from first hop 1210 to second hop 1212, based on a frequency shift of Δfₜ_{₁}=X⁴*Δfₜ_{ₒ}. A downward hop of two grids can be performed from second hop 1212 to third hop 1214, based on a frequency shift of Δfₜ_{₂}=Δfₜ_{₁}/X². In examples where a pseudo-random frequency hopping pattern is utilized, the number of frequency grids in the hop size (e.g., the value of m) can be determined pseudo-randomly. In some aspects, both the hop size and the hop direction can be determined pseudo-randomly.

For example, a pseudo-random hop step size can be determined based on a cell ID associated with the device (e.g., the cell ID associated with the ambient IoT device and used to communicate with the network node/cellular network) and/or can be determined based on a group ID associated with the device. A corresponding network node can reproduce the same calculation and may anticipate the pseudo-random hopping that will be performed by a given ambient IoT device to transmit its corresponding PRACH.

FIG. 12B depicts an example of a frequency hopping pattern that includes fixed size frequency hopping steps and pseudo-random frequency hopping steps. For example, for a set of time-frequency resources 1200b, a first hop 1220 can be associated with a starting frequency shift Δfₜ_{ₒ}. The frequency hopping pattern can include a fixed single-grid upward hop from 1220 to 1222, a random hop from 1222 to 1224, and a fixed single-grid downward hop from 1224 to 1226.

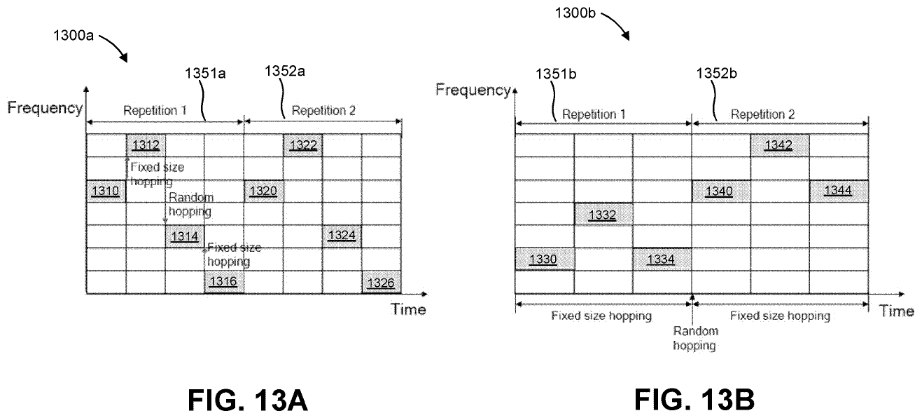

In one illustrative example, a frequency hopping pattern may be repeated one or more times during PRACH transmission. For example, repetition of a frequency hopping pattern may be used to improve a reliability of the PRACH transmission. In some aspects, a given frequency hopping pattern can be repeated without adjustment. For example, FIG. 13A is a diagram 1300a illustrating an example in which a same frequency hopping pattern is repeated during a first repetition 1351a and a second repetition 1352a. As illustrated, the frequency hopping pattern can include a fixed two-grid upward hop, a pseudo-random hop, and a fixed two-grid downward hop. The same frequency hopping pattern can be repeated for both repetition 1 (1351a) and repetition 2 (1352a). For example, repetition 1 can be performed based on a two-grid upward hop from 1310 to 1312, a pseudo-random four grid downward hop from 1312 to 1314, and a two-grid downward hop from 1314 to 1316. In one illustrative example, repetition of a frequency hopping pattern can be performed using the different time resources that are included in the same subset of time-frequency resources (e.g., each repetition can use different time resources of the particular subset of time-frequency resources associated with a device). For instance, the time-frequency resources depicted in FIG. 13A can be included in a particular subset of time-frequency resources (e.g., the time-frequency grid of FIG. 13A can itself be a subset of a larger time-frequency grid). In some aspects, the first repetition 1351a can use a first plurality of time resources of the particular subset of time-frequency resources to transmit a PRACH signal and the second repetition 1352a can use a second plurality of time resources of the particular subset of time-frequency resources to transmit a second PRACH signal. The same frequency resources can be shared across the first repetition 1351a and the second repetition 1352a. For instance, first repetition 1351a and second repetition 1352a may each utilize some (or all) of the frequency resources included in the particular subset of time-frequency resources.

Repetition can be performed using a transition hop determined between the ending hop position of the frequency hopping pattern (e.g., grid 1316, 1326) and the starting hop position of the frequency hopping pattern (e.g., grid 1310, 1320). For example, Repetition 2 (1352a) can begin based on four-grid upward hop from 1316, which is the last hop of Repetition 1 (1351a). From 1320, Repetition 2 (1352a) can be performed using the same two up-pseudorandom-two down frequency hopping pattern associated with Repetition 1 (1351a). In some aspects, repetition can be performed using the same pseudo-random hop each repetition (e.g., as illustrated, Repetition 1 and Repetition 2 both use a four-grid downward hop as the pseudo-random hop). In some examples, repetition can be performed using a newly determined pseudo-random hop for some (or all) of the repetitions, such that the hop size and/or direction between two different repetitions is the same or different.

In another illustrative example, repetition can be performed based on using fixed-size hopping within each repetition and pseudo-random hopping between repetitions. For example, if each repetition is performed for a group of three consecutive symbol groups (e.g., three consecutive time-frequency resources used to transmit the three consecutive symbol groups, as described with respect to FIG. 7), the same fixed size frequency hopping pattern can be applied between each group of three consecutive symbol groups. As illustrated, the fixed frequency hopping pattern can be implemented as a fixed two-grid upward hop and a fixed two-grid downward hop. For example, within first repetition 1351b (e.g., Repetition 1), the frequency hopping can be performed as 1330-1332-1334. Within the second repetition 1352b (e.g., Repetition 2), the frequency hopping can use the same frequency hopping pattern and be performed as 1340-1342-1344. The transition between repetitions (e.g., the hop from 1334 to 1340) can be a pseudo-random hop. For example, a pseudo-random three-grid upward hop can be performed from 1334 to 1340. In some examples, a different pseudo-random hop can be determined and used to hop from 1344 to the beginning of a third repetition that follows repetition 1352b (not shown).

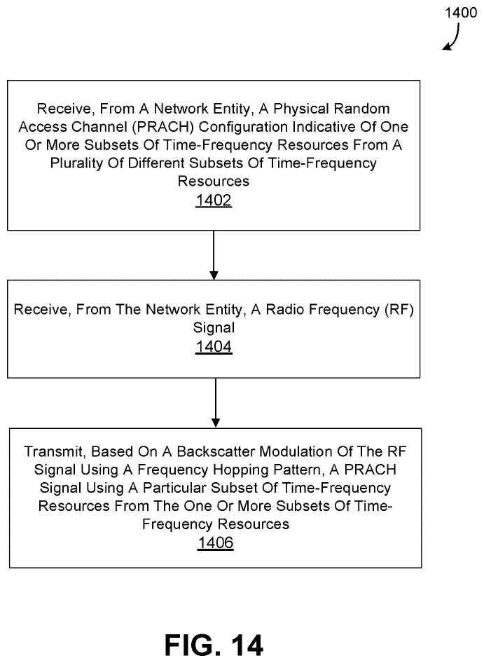

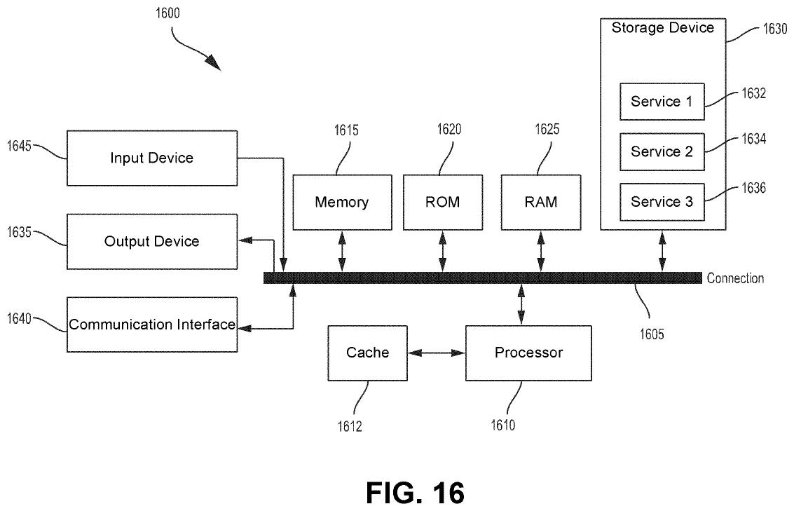

FIG. 14 is a flowchart diagram illustrating an example of a process 1400 for wireless communications. The process 1400 may be performed by a first apparatus or by a component or system (e.g., a chipset) of the first apparatus. The first apparatus may be an energy harvesting (EH)-capable device (e.g., including a backscatter transmitter), which can be in the form of an IoT device (e.g., an ambient IoT device), a radio-frequency identification (RFID) tag, a UE (e.g., a mobile device such as a mobile phone, a network-connected wearable such as a watch, an extended reality device such as a virtual reality (VR) device or augmented reality (AR) device, a vehicle or component or system of a vehicle, or other type of UE) or other type of network node. The operations of the process 1400 may be implemented as software components that are executed and run on one or more processors (e.g., processor 1610 of FIG. 16 or other processor(s)). Further, the transmission and reception of signals by the wireless communications device in the process 1400 may be enabled, for example, by one or more antennas and/or one or more transceivers (e.g., antenna(s) and/or wireless transceiver(s) of any of FIG. 2, FIG. 4, FIG. 5, FIG. 6, FIG. 16, etc.).

At operation 1402, the first apparatus (or component thereof) can receive (e.g., via the antenna(s) and/or wireless transceiver(s) of any of FIG. 2, FIG. 4, FIG. 5, FIG. 6, FIG. 16, etc.), from a network entity, a Physical Random Access Channel (PRACH) configuration indicative of one or more subsets of time-frequency resources from a plurality of different subsets of time-frequency resources. In some aspects, the PRACH configuration is indicative of only the particular subset of time-frequency resources. In some cases, the PRACH configuration is indicative of each respective subset of time-frequency resources from the plurality of different subsets of time-frequency resource and selection information associated with each respective subset of time-frequency resources. In some examples, the particular subset of time-frequency resources is based on the selection information. The selection information can include a traffic type, a coverage level, an energy level associated with a respective subset of time-frequency resources from the plurality of different subsets of time-frequency resources, any combination thereof, and/or other information.

In some aspects, the PRACH configuration is indicative of the particular subset of time-frequency resources. In some cases, the particular subset of time-frequency resources is a common subset of PRACH resources associated with a plurality of apparatuses including the first apparatus.

In some examples, the plurality of different subsets of time-frequency resources includes a first subset of time-frequency resources associated with a first plurality of frequency resources and a second subset of time-frequency resources associated with a second plurality of frequency resources. The first plurality of frequency resources is different from the second plurality of frequency resources. Additionally or alternatively, in some aspects, the plurality of different subsets of time-frequency resources includes a first subset of time-frequency resources associated with a first plurality of time resources and a second subset of time-frequency resources associated with a second plurality of time resources. The first plurality of time resources is different from the second plurality of time resources. In some cases, the first plurality of time resources is non-overlapping with the second plurality of time resources. In some cases, the second plurality of time resources includes one or more time resources included in the first plurality of time resources. In some examples, a quantity of time resources included in the second plurality of time resources is greater than a quantity of time resources included in the first plurality of time resources.

At operation 1404, the first apparatus (or component thereof) can receive (e.g., via the antenna(s) and/or wireless transceiver(s) of any of FIG. 2, FIG. 4, FIG. 5, FIG. 6, FIG. 16, etc.), from the network entity, a radio frequency (RF) signal.

At operation 1406, the first apparatus (or component thereof) can transmit (e.g., via the antenna(s) and/or wireless transceiver(s) of any of FIG. 2, FIG. 4, FIG. 5, FIG. 6, FIG. 16, etc.), based on a backscatter modulation of the RF signal using a frequency hopping pattern, a PRACH signal using a particular subset of time-frequency resources from the one or more subsets of time-frequency resources.

In some aspects, the particular subset of time-frequency resources is associated with a particular subset of frequency resources included in a plurality of time-frequency resources. In some cases, to transmit the PRACH signal, the first apparatus (or component thereof) can randomly select a frequency resource included in the particular subset of frequency resources as a starting frequency resource for the frequency hopping pattern. In some cases, to transmit the PRACH signal, the first apparatus (or component thereof) can select, based on a hash of an identifier associated with the first apparatus, a frequency resource included in the particular subset of frequency resources as a starting frequency resource for the frequency hopping pattern.

In some examples, the frequency hopping pattern is based on at least one fixed frequency hopping step size. The PRACH configuration can be indicative of the frequency hopping pattern and/or the at least one fixed frequency hopping step size.

In some cases, the first apparatus is included in a plurality of apparatuses (which are different from the first apparatus) associated with the particular subset of time-frequency resources and the frequency hopping pattern. In such cases, the at least one fixed frequency hopping step size associated with the first apparatus can be different than a respective fixed frequency hopping step size associated with one or more apparatuses of the plurality of apparatuses.

In some aspects, the frequency hopping pattern is a pseudo-random frequency hopping pattern based on at least one pseudo-random frequency hopping step size. For instance, the at least one pseudo-random frequency hopping step size can be based on a cell identifier or an identifier associated with the particular subset of time-frequency resources.

In some cases, the first apparatus (or component thereof) can transmit (e.g., via the antenna(s) and/or wireless transceiver(s) of any of FIG. 2, FIG. 4, FIG. 5, FIG. 6, FIG. 16, etc.) the PRACH signal using a first plurality of time resources of the particular subset of time-frequency resources. The first apparatus (or component thereof) can transmit, based on the backscatter modulation of the RF signal using the frequency hopping pattern, a second PRACH signal using a second plurality of time resources of the particular subset of time-frequency resources. In some aspects, the PRACH signal and the second PRACH signal are transmitted using a same starting frequency resource. In some examples, to transmit the PRACH signal, the first apparatus (or component thereof) can use a first starting frequency resource. In some aspects, to transmit the second PRACH signal, the first apparatus (or component thereof) can use a second starting frequency resource. In some cases, a difference between the first starting frequency resource and the second starting frequency resource is based on a pseudo-random hopping step size.

In some aspects, the PRACH configuration is indicative of a frequency hopping step size of the frequency hopping pattern. In some cases, the frequency hopping step size is based on capability information associated with the first apparatus.

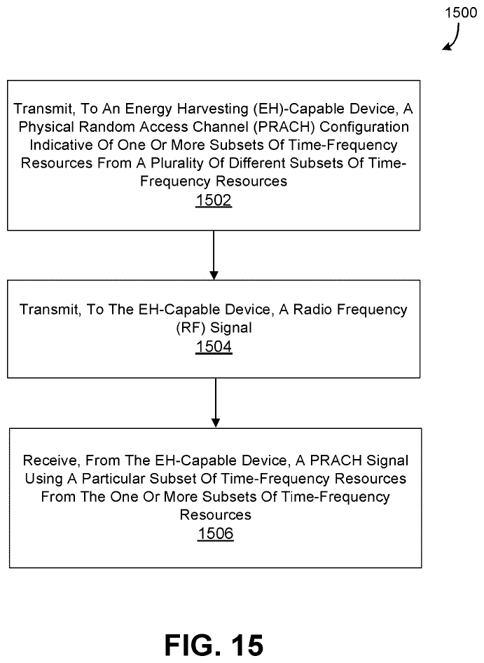

FIG. 15 is a flowchart diagram illustrating an example of a process 1500 for wireless communications. The process 1500 may be performed by a network entity or by a component or system (e.g., a chipset) of the network entity. The network entity may be a base station (e.g., the base station 102 of FIG. 1 and/or FIG. 2, which can be a gNB, an eNB, etc.), a portion of the gNB (e.g., the CU 310, the DU 330, the RU 340, the non-real time RIC 315, and/or the near-real time RIC 325 of the disaggregated base station 300 of FIG. 3), an access point (AP), a router, and/or other network entity. The operations of the process 1500 may be implemented as software components that are executed and run on one or more processors (e.g., controller/processor 240 of the base station of FIG. 2, processor 1610 of FIG. 16, or other processor(s)). Further, the transmission and reception of signals by the wireless communications device in the process 1500 may be enabled, for example, by one or more antennas and/or one or more transceivers (e.g., antenna(s) and/or wireless transceiver(s) of any of FIG. 2, FIG. 3, FIG. FIG. 6, FIG. 16, etc.).

At block 1502, the network entity (or component thereof) can transmit (e.g., via antenna(s) and/or wireless transceiver(s) of any of FIG. 2, FIG. 3, FIG. FIG. 6, FIG. 16, etc.), to an energy harvesting (EH)-capable device, a Physical Random Access Channel (PRACH) configuration indicative of one or more subsets of time-frequency resources from a plurality of different subsets of time-frequency resources. In some aspects, the PRACH configuration is indicative of only the particular subset of time-frequency resources. In some cases, the PRACH configuration is indicative of each respective subset of time-frequency resources from the plurality of different subsets of time-frequency resources and selection information associated with each respective subset of time-frequency resources. In some examples, the selection information includes a traffic type, a coverage level, an energy level associated with a respective subset of time-frequency resources from the plurality of different subsets of time-frequency resources, any combination thereof, and/or other information. In some aspects, the PRACH configuration is indicative of a frequency hopping pattern or a frequency hopping step size associated with the frequency hopping pattern. In some cases, the network entity (or component thereof) can determine the one or more subsets of time-frequency resources based on dividing a plurality of time-frequency resources based on at least one of frequency or time.

At block 1504, the network entity (or component thereof) can transmit (e.g., via antenna(s) and/or wireless transceiver(s) of any of FIG. 2, FIG. 3, FIG. FIG. 6, FIG. 16, etc.), to the EH-capable device, a radio frequency (RF) signal.

At block 1506, the network entity (or component thereof) can receive (e.g., via antenna(s) and/or wireless transceiver(s) of any of FIG. 2, FIG. 3, FIG. FIG. 6, FIG. 16, etc.), from the EH-capable device, a PRACH signal using a particular subset of time-frequency resources from the one or more subsets of time-frequency resources. In some aspects, the PRACH signal is a backscattered RF signal associated with the RF signal.

In some examples, the processes described herein (e.g., process 1400, the process 1500, and/or other process described herein) may be performed by a computing device or apparatus (e.g., a network node such as a UE, base station, a portion of a base station, etc.). For example, as noted above, the process 1400 may be performed by a UE and/or an energy harvesting device and the process 1500 may be performed by a network entity such as a base station or other network entity. In some examples, the process 1400 may be performed by an energy harvesting device with an architecture that is the same as or similar to that of the energy harvesting device 500 illustrated in FIG. 5. In some examples, the process 1400 may be performed by an ambient IoT device with an architecture that is the same as or similar to that of the ambient IoT device illustrated in FIG. 6.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 1400 and the process 1500 are illustrated as a logical flow diagram, the operation of which represent a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 1400, the process 1500, and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 16 is a diagram illustrating an example of a system for implementing certain aspects of the present technology. In particular, FIG. 16 illustrates an example of computing system 1600, which may be for example any computing device making up internal computing system, a remote computing system, a camera, or any component thereof in which the components of the system are in communication with each other using connection 1605. Connection 1605 may be a physical connection using a bus, or a direct connection into processor 1610, such as in a chipset architecture. Connection 1605 may also be a virtual connection, networked connection, or logical connection.

In some aspects, computing system 1600 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 1600 includes at least one processing unit (CPU or processor) 1610 and connection 1605 that communicatively couples various system components including system memory 1615, such as read-only memory (ROM) 1620 and random access memory (RAM) 1625 to processor 1610. Computing system 1600 may include a cache 1615 of high-speed memory connected directly with, in close proximity to, or integrated as part of processor 1610.

Processor 1610 may include any general-purpose processor and a hardware service or software service, such as services 1632, 1634, and 1636 stored in storage device 1630, configured to control processor 1610 as well as a special-purpose processor where software instructions are incorporated into the actual processor design. Processor 1610 may essentially be a completely self-contained computing system, containing multiple cores or processors, a bus, memory controller, cache, etc. A multi-core processor may be symmetric or asymmetric.

To enable user interaction, computing system 1600 includes an input device 1645, which may represent any number of input mechanisms, such as a microphone for speech, a touch-sensitive screen for gesture or graphical input, keyboard, mouse, motion input, speech, etc. Computing system 1600 may also include output device 1635, which may be one or more of a number of output mechanisms. In some instances, multimodal systems may enable a user to provide multiple types of input/output to communicate with computing system 1600.

Computing system 1600 may include communications interface 1640, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1640 may also include one or more Global Navigation Satellite System (GNSS) receivers or transceivers that are used to determine a location of the computing system 1600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1630 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1630 may include software services, servers, services, etc., that when the code that defines such software is executed by the processor 1610, it causes the system to perform a function. In some aspects, a hardware service that performs a particular function may include the software component stored in a computer-readable medium in connection with the necessary hardware components, such as processor 1610, connection 1605, output device 1635, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Illustrative aspects of the disclosure include:

Aspect 1. A first apparatus for wireless communication, comprising: at least one memory; and at least one processor coupled to the at least one memory, wherein the at least one processor is configured to: receive, from a network entity, a Physical Random Access Channel (PRACH) configuration indicative of one or more subsets of time-frequency resources from a plurality of different subsets of time-frequency resources; receive, from the network entity, a radio frequency (RF) signal; and transmit, based on a backscatter modulation of the RF signal using a frequency hopping pattern, a PRACH signal using a particular subset of time-frequency resources from the one or more subsets of time-frequency resources.

Aspect 2. The first apparatus of Aspect 1, wherein the PRACH configuration is indicative of only the particular subset of time-frequency resources.

Aspect 3. The first apparatus of any one of Aspects 1 or 2, wherein the PRACH configuration is indicative of: each respective subset of time-frequency resources from the plurality of different subsets of time-frequency resources; and selection information associated with each respective subset of time-frequency resources.

Aspect 4. The first apparatus of Aspect 3, wherein the particular subset of time-frequency resources is based on the selection information.

Aspect 5. The first apparatus of any one of Aspects 3 or 4, wherein the selection information includes at least one of a traffic type, a coverage level, or an energy level associated with a respective subset of time-frequency resources from the plurality of different subsets of time-frequency resources.

Aspect 6. The first apparatus of any one of Aspects 1 to 5, wherein the particular subset of time-frequency resources is associated with a particular subset of frequency resources included in a plurality of time-frequency resources.

Aspect 7. The first apparatus of Aspect 6, wherein, to transmit the PRACH signal, the at least one processor is configured to: randomly select a frequency resource included in the particular subset of frequency resources as a starting frequency resource for the frequency hopping pattern.

Aspect 8. The first apparatus of any one of Aspects 6 or 7, wherein, to transmit the PRACH signal, the at least one processor is configured to: select, based on a hash of an identifier associated with the first apparatus, a frequency resource included in the particular subset of frequency resources as a starting frequency resource for the frequency hopping pattern.

Aspect 9. The first apparatus of any one of Aspects 1 to 8, wherein the frequency hopping pattern is based on at least one fixed frequency hopping step size.

Aspect 10. The first apparatus of Aspect 9, wherein the PRACH configuration is indicative of at least one of the frequency hopping pattern or the at least one fixed frequency hopping step size.

Aspect 11. The first apparatus of any one of Aspects 9 or 10, wherein: the first apparatus is included in a plurality of apparatuses associated with the particular subset of time-frequency resources and the frequency hopping pattern; and the at least one fixed frequency hopping step size associated with the first apparatus is different than a respective fixed frequency hopping step size associated with one or more apparatuses of the plurality of apparatuses, wherein the one or more apparatuses are different from the first apparatus.

Aspect 12. The first apparatus of any one of Aspects 1 to 11, wherein the frequency hopping pattern is a pseudo-random frequency hopping pattern based on at least one pseudo-random frequency hopping step size.

Aspect 13. The first apparatus of Aspect 12, wherein the at least one pseudo-random frequency hopping step size is based on a cell identifier or an identifier associated with the particular subset of time-frequency resources.

Aspect 14. The first apparatus of any one of Aspects 1 to 13, wherein the at least one processor is configured to: transmit the PRACH signal using a first plurality of time resources of the particular subset of time-frequency resources; and transmit, based on the backscatter modulation of the RF signal using the frequency hopping pattern, a second PRACH signal using a second plurality of time resources of the particular subset of time-frequency resources.

Aspect 15. The first apparatus of Aspect 14, wherein the PRACH signal and the second PRACH signal are transmitted using a same starting frequency resource.

Aspect 16. The first apparatus of any one of Aspects 14 or 15, wherein: to transmit the PRACH signal, the at least one processor is configured to use a first starting frequency resource; and to transmit the second PRACH signal, the at least one processor is configured to use a second starting frequency resource, wherein a difference between the first starting frequency resource and the second starting frequency resource is based on a pseudo-random hopping step size.

Aspect 17. The first apparatus of any one of Aspects 1 to 16, wherein the PRACH configuration is indicative of the particular subset of time-frequency resources, and wherein the particular subset of time-frequency resources is a common subset of PRACH resources associated with a plurality of apparatuses including the first apparatus.

Aspect 18. The first apparatus of any one of Aspects 1 to 17, wherein: the plurality of different subsets of time-frequency resources includes a first subset of time-frequency resources associated with a first plurality of frequency resources and a second subset of time-frequency resources associated with a second plurality of frequency resources, wherein the first plurality of frequency resources is different from the second plurality of frequency resources.

Aspect 19. The first apparatus of any one of Aspects 1 to 18, wherein: the plurality of different subsets of time-frequency resources includes a first subset of time-frequency resources associated with a first plurality of time resources and a second subset of time-frequency resources associated with a second plurality of time resources, and wherein the first plurality of time resources is different from the second plurality of time resources

Aspect 20. The first apparatus of Aspect 19, wherein the first plurality of time resources is non-overlapping with the second plurality of time resources.

Aspect 21. The first apparatus of any one of Aspects 19 or 20, wherein the second plurality of time resources includes one or more time resources included in the first plurality of time resources.

Aspect 22. The first apparatus of Aspect 21, wherein a quantity of time resources included in the second plurality of time resources is greater than a quantity of time resources included in the first plurality of time resources.

Aspect 23. The first apparatus of any one of Aspects 1 to 22, wherein the PRACH configuration is indicative of a frequency hopping step size of the frequency hopping pattern, and wherein the frequency hopping step size is based on capability information associated with the first apparatus.

Aspect 24. A method for wireless communication performed by a first apparatus, comprising: receiving, from a network entity, a Physical Random Access Channel (PRACH) configuration indicative of one or more subsets of time-frequency resources from a plurality of different subsets of time-frequency resources; receiving, from the network entity, a radio frequency (RF) signal; and transmitting, based on a backscatter modulation of the RF signal using a frequency hopping pattern, a PRACH signal using a particular subset of time-frequency resources from the one or more subsets of time-frequency resources.

Aspect 25. The method of Aspect 24, wherein the PRACH configuration is indicative of only the particular subset of time-frequency resources.

Aspect 26. The method of any one of Aspects 24 or 25, wherein the PRACH configuration is indicative of: each respective subset of time-frequency resources from the plurality of different subsets of time-frequency resources; and selection information associated with each respective subset of time-frequency resources.

Aspect 27. The method of Aspect 26, wherein the particular subset of time-frequency resources is based on the selection information.

Aspect 28. The method of any one of Aspects 26 or 27, wherein the selection information includes at least one of a traffic type, a coverage level, or an energy level associated with a respective subset of time-frequency resources from the plurality of different subsets of time-frequency resources.

Aspect 29. The method of any one of Aspects 24 to 28, wherein the particular subset of time-frequency resources is associated with a particular subset of frequency resources included in a plurality of time-frequency resources.

Aspect 30. The method of Aspect 29, wherein transmitting the PRACH signal comprises: randomly selecting a frequency resource included in the particular subset of frequency resources as a starting frequency resource for the frequency hopping pattern.

Aspect 31. The method of any one of Aspects 29 or 30, wherein transmitting the PRACH signal comprises: selecting, based on a hash of an identifier associated with the first apparatus, a frequency resource included in the particular subset of frequency resources as a starting frequency resource for the frequency hopping pattern.

Aspect 32. The method of any one of Aspects 24 to 31, wherein the frequency hopping pattern is based on at least one fixed frequency hopping step size.

Aspect 33. The method of Aspect 32, wherein the PRACH configuration is indicative of at least one of the frequency hopping pattern or the at least one fixed frequency hopping step size.

Aspect 34. The method of any one of Aspects 32 or 33, wherein: the first apparatus is included in a plurality of apparatuses associated with the particular subset of time-frequency resources and the frequency hopping pattern; and the at least one fixed frequency hopping step size associated with the first apparatus is different than a respective fixed frequency hopping step size associated with one or more apparatuses of the plurality of apparatuses, wherein the one or more apparatuses are different from the first apparatus.

Aspect 35. The method of any one of Aspects 24 to 34, wherein the frequency hopping pattern is a pseudo-random frequency hopping pattern based on at least one pseudo-random frequency hopping step size.

Aspect 36. The method of Aspect 35, wherein the at least one pseudo-random frequency hopping step size is based on a cell identifier or an identifier associated with the particular subset of time-frequency resources.

Aspect 37. The method of any one of Aspects 24 to 36, further comprising: transmitting the PRACH signal using a first plurality of time resources of the particular subset of time-frequency resources; and transmitting, based on the backscatter modulation of the RF signal using the frequency hopping pattern, a second PRACH signal using a second plurality of time resources of the particular subset of time-frequency resources.

Aspect 38. The method of Aspect 37, wherein the PRACH signal and the second PRACH signal are transmitted using a same starting frequency resource.

Aspect 39. The method of any one of Aspects 37 or 38, wherein: transmitting the PRACH signal comprises using a first starting frequency resource; and transmitting the second PRACH signal comprises using a second starting frequency resource, wherein a difference between the first starting frequency resource and the second starting frequency resource is based on a pseudo-random hopping step size.

Aspect 40. The method of any one of Aspects 24 to 39, wherein the PRACH configuration is indicative of the particular subset of time-frequency resources, and wherein the particular subset of time-frequency resources is a common subset of PRACH resources associated with a plurality of apparatuses including the first apparatus.

Aspect 41. The method of any one of Aspects 24 to 40, wherein: the plurality of different subsets of time-frequency resources includes a first subset of time-frequency resources associated with a first plurality of frequency resources and a second subset of time-frequency resources associated with a second plurality of frequency resources, wherein the first plurality of frequency resources is different from the second plurality of frequency resources.

Aspect 42. The method of any one of Aspects 24 to 41, wherein: the plurality of different subsets of time-frequency resources includes a first subset of time-frequency resources associated with a first plurality of time resources and a second subset of time-frequency resources associated with a second plurality of time resources, and wherein the first plurality of time resources is different from the second plurality of time resources

Aspect 43. The method of Aspect 42, wherein the first plurality of time resources is non-overlapping with the second plurality of time resources.

Aspect 44. The method of any one of Aspects 42 or 43, wherein the second plurality of time resources includes one or more time resources included in the first plurality of time resources.

Aspect 45. The method of Aspect 44, wherein a quantity of time resources included in the second plurality of time resources is greater than a quantity of time resources included in the first plurality of time resources.

Aspect 46. The method of any one of Aspects 24 to 45, wherein the PRACH configuration is indicative of a frequency hopping step size of the frequency hopping pattern, and wherein the frequency hopping step size is based on capability information associated with the first apparatus.

Aspect 47. A network entity for wireless communication, comprising: at least one memory; and at least one processor coupled to the at least one memory, the at least one processor configured to: transmit, to an energy harvesting (EH)-capable device, a Physical Random Access Channel (PRACH) configuration indicative of one or more subsets of time-frequency resources from a plurality of different subsets of time-frequency resources; transmit, to the EH-capable device, a radio frequency (RF) signal; and receive, from the EH-capable device, a PRACH signal using a particular subset of time-frequency resources from the one or more subsets of time-frequency resources.

Aspect 48. The network entity of Aspect 47, wherein the PRACH signal is a backscattered RF signal associated with the RF signal.

Aspect 49. The network entity of any one of Aspects 47 or 48, wherein the PRACH configuration is indicative of only the particular subset of time-frequency resources.

Aspect 50. The network entity of any one of Aspects 47 to 49, wherein the PRACH configuration is indicative of: each respective subset of time-frequency resources from the plurality of different subsets of time-frequency resources; and selection information associated with each respective subset of time-frequency resources.

Aspect 51. The network entity of Aspect 50, wherein the selection information includes at least one of a traffic type, a coverage level, or an energy level associated with a respective subset of time-frequency resources from the plurality of different subsets of time-frequency resources.

Aspect 52. The network entity of any one of Aspects 47 to 51, wherein the PRACH configuration is indicative of at least one of a frequency hopping pattern or a frequency hopping step size associated with the frequency hopping pattern.

Aspect 53. The network entity of any one of Aspects 47 to 52, wherein the at least one processor is configured to determine the one or more subsets of time-frequency resources based on dividing a plurality of time-frequency resources based on at least one of frequency or time.

Aspect 54. A method for wireless communication performed by a network entity, the method comprising: transmitting, to an energy harvesting (EH)-capable device, a Physical Random Access Channel (PRACH) configuration indicative of one or more subsets of time-frequency resources from a plurality of different subsets of time-frequency resources; transmitting, to the EH-capable device, a radio frequency (RF) signal; and receiving, from the EH-capable device, a PRACH signal using a particular subset of time-frequency resources from the one or more subsets of time-frequency resources.

Aspect 55. The method of Aspect 54, wherein the PRACH signal is a backscattered RF signal associated with the RF signal.

Aspect 56. The method of any one of Aspects 54 or 55, wherein the PRACH configuration is indicative of only the particular subset of time-frequency resources.

Aspect 57. The method of any one of Aspects 54 to 56, wherein the PRACH configuration is indicative of: each respective subset of time-frequency resources from the plurality of different subsets of time-frequency resources; and selection information associated with each respective subset of time-frequency resources.

Aspect 58. The method of Aspect 57, wherein the selection information includes at least one of a traffic type, a coverage level, or an energy level associated with a respective subset of time-frequency resources from the plurality of different subsets of time-frequency resources.

Aspect 59. The method of any one of Aspects 54 to 58, wherein the PRACH configuration is indicative of at least one of a frequency hopping pattern or a frequency hopping step size associated with the frequency hopping pattern.

Aspect 60. The method of any one of Aspects 54 to 59, wherein the at least one processor is configured to determine the one or more subsets of time-frequency resources based on dividing a plurality of time-frequency resources based on at least one of frequency or time.

Aspect 61. A non-transitory computer-readable storage medium having stored thereon instructions which, when executed by one or more processors, cause the one or more processors to perform any of the operations of any of Aspects 24 to 46.

Aspect 62. An apparatus comprising means for performing any of the operations of any of Aspects 24 to 46.

Aspect 63. A non-transitory computer-readable storage medium having stored thereon instructions which, when executed by one or more processors, cause the one or more processors to perform any of the operations of any of Aspects 54 to 60.

Aspect 64. An apparatus comprising means for performing any of the operations of any of Aspects 54 to 60.

1. A first apparatus for wireless communication, comprising:
at least one memory; and
at least one processor coupled to the at least one memory, wherein the at least one processor is configured to:
receive, from a network entity, a Physical Random Access Channel (PRACH) configuration indicative of one or more subsets of time-frequency resources from a plurality of different subsets of time-frequency resources;
receive, from the network entity, a radio frequency (RF) signal; and
transmit, based on a backscatter modulation of the RF signal using a frequency hopping pattern, a PRACH signal using a particular subset of time-frequency resources from the one or more subsets of time-frequency resources.

2. The first apparatus of claim 1, wherein the PRACH configuration is indicative of only the particular subset of time-frequency resources.

3. The first apparatus of claim 1, wherein the PRACH configuration is indicative of:
each respective subset of time-frequency resources from the plurality of different subsets of time-frequency resources; and
selection information associated with each respective subset of time-frequency resources.

4. The first apparatus of claim 3, wherein the particular subset of time-frequency resources is based on the selection information.

5. The first apparatus of claim 3, wherein the selection information includes at least one of a traffic type, a coverage level, or an energy level associated with a respective subset of time-frequency resources from the plurality of different subsets of time-frequency resources.

6. The first apparatus of claim 1, wherein the particular subset of time-frequency resources is associated with a particular subset of frequency resources included in a plurality of time-frequency resources.

7. The first apparatus of claim 6, wherein, to transmit the PRACH signal, the at least one processor is configured to:
randomly select a frequency resource included in the particular subset of frequency resources as a starting frequency resource for the frequency hopping pattern.

8. The first apparatus of claim 6, wherein, to transmit the PRACH signal, the at least one processor is configured to:
select, based on a hash of an identifier associated with the first apparatus, a frequency resource included in the particular subset of frequency resources as a starting frequency resource for the frequency hopping pattern.

9. The first apparatus of claim 1, wherein the frequency hopping pattern is based on at least one fixed frequency hopping step size.

10. The first apparatus of claim 9, wherein the PRACH configuration is indicative of at least one of the frequency hopping pattern or the at least one fixed frequency hopping step size.

11. The first apparatus of claim 9, wherein:
the first apparatus is included in a plurality of apparatuses associated with the particular subset of time-frequency resources and the frequency hopping pattern; and
the at least one fixed frequency hopping step size associated with the first apparatus is different than a respective fixed frequency hopping step size associated with one or more apparatuses of the plurality of apparatuses, wherein the one or more apparatuses are different from the first apparatus.

12. The first apparatus of claim 1, wherein the frequency hopping pattern is a pseudo-random frequency hopping pattern based on at least one pseudo-random frequency hopping step size.

13. The first apparatus of claim 12, wherein the at least one pseudo-random frequency hopping step size is based on a cell identifier or an identifier associated with the particular subset of time-frequency resources.

14. The first apparatus of claim 1, wherein the at least one processor is configured to:
transmit the PRACH signal using a first plurality of time resources of the particular subset of time-frequency resources; and
transmit, based on the backscatter modulation of the RF signal using the frequency hopping pattern, a second PRACH signal using a second plurality of time resources of the particular subset of time-frequency resources.

15. The first apparatus of claim 14, wherein the PRACH signal and the second PRACH signal are transmitted using a same starting frequency resource.

16. The first apparatus of claim 14, wherein:
to transmit the PRACH signal, the at least one processor is configured to use a first starting frequency resource; and
to transmit the second PRACH signal, the at least one processor is configured to use a second starting frequency resource, wherein a difference between the first starting frequency resource and the second starting frequency resource is based on a pseudo-random hopping step size.

17. The first apparatus of claim 1, wherein the PRACH configuration is indicative of the particular subset of time-frequency resources, and wherein the particular subset of time-frequency resources is a common subset of PRACH resources associated with a plurality of apparatuses including the first apparatus.

18. The first apparatus of claim 1, wherein:
the plurality of different subsets of time-frequency resources includes a first subset of time-frequency resources associated with a first plurality of frequency resources and a second subset of time-frequency resources associated with a second plurality of frequency resources, wherein the first plurality of frequency resources is different from the second plurality of frequency resources.

19. The first apparatus of claim 1, wherein:
the plurality of different subsets of time-frequency resources includes a first subset of time-frequency resources associated with a first plurality of time resources and a second subset of time-frequency resources associated with a second plurality of time resources, and wherein the first plurality of time resources is different from the second plurality of time resources.

20. The first apparatus of claim 19, wherein the first plurality of time resources is non-overlapping with the second plurality of time resources.

21-30. (canceled)
